(19) United States
(12) Patent Application Publication
(10) Pub. No.: US 2011/0004841 A1
(43) Pub. Date: Jan. 6, 2011

(54) CONVERSATIONAL INTERFACE HAVING VISUAL REPRESENTATIONS FOR INTERACTIVE DATA GATHERING

(76) Inventors: Tyler Gildred, Santa Ynez, CA (US); Travis Purdy, Shell Beach, CA (US)

Correspondence Address: Cislo & Thomas LLP, 1333 2nd Street, Suite #500, Santa Monica, CA, 90401-4110, US

(21) Appl. No.: 12/830,265

(22) Filed: Jul. 2, 2010

Related U.S. Application Data
(63) Continuation-in-part of application No. 12/253,503, filed on Oct. 17, 2008.
(60) Provisional application No. 61/222,842, filed on Jul. 2, 2009.
(60) Provisional application No. 60/981,416, filed on Oct. 19, 2007.

(51) Int. Cl. G06F 3/048

(52) U.S. Cl. 715/780

(57) ABSTRACT

An interactive application on a graphical user interface (GUI). The application allows a user to communicate with their device through a two-way dialogue between a digital character and a user profile operated by the user, the conversation driven by an XML based document and having behavior identical to short message services. In one illustrative embodiment, the user interface includes chat bubbles between the digital character and the user profile to obtain information from the user. Associated with the chat bubbles are input controls, the input controls allowing the user to enter in information. The user interface provides single selection controls, multi-selection controls, numeric controls, text entry controls, physical dimension controls, and pricing selection controls to provide a user friendly environment.

### CROSS-REFERENCES TO RELATED APPLICATIONS

This patent application claims the benefit of U.S. Provisional Patent Application Ser. No. 61/222,842, filed Jul. 2, 2009, and is a continuation-in-part of U.S. patent application Ser. No. 12/253,503, filed Oct. 17, 2008, which claims the benefit of U.S. Provisional Application Ser. No. 60/681,416, filed Oct. 19, 2007, all of which are hereby incorporated in their entirety by this reference, including any appendices, screen shots, and references therein.

### BACKGROUND OF THE INVENTION

1. Field of the Invention

This invention relates to data gathering through a user interface, and, more particularly, to an interactive application for a user to communicate with their mobile device which implements a two-way dialogue between a digital character and a user profile operated by the user, the conversation driven by an XML based document and having behavior of short message services.

2. Description of the Related Art

Mobile devices, such as personal digital assistants, digital media players and mobile phones, often include displays which are used to present graphical user interfaces. These user interfaces provide means for the mobile devices to present information to users. Since mobile devices are generally small and lightweight, it is difficult for mobile devices to include large displays. Because of this, there are difficult design tradeoffs in designing mobile devices since a larger display typically requires a larger device.

As applications on mobile devices become increasingly powerful, a key target in developing successful software is to provide functionality in a simple and consumable way. The functionality provided by applications is presented to the user through a user interface, which themselves have seen a corresponding increase in complexity as the capabilities of the underlying application grows. Given that the user interface acts as the boundary between the user and the application, a poorly designed or overly complex user interface can markedly reduce a user's satisfaction with the product, or even prevent the user from benefiting from the application's capabilities.

For the purpose of the discussion herein, the complexity of a user interface is defined by its “navigability” (the ease of navigating through the user interface) and its “simplicity” (the ease of exercising functionality presented by the user interface). Navigability reflects, for example, how many panels the user has to navigate through to perform a given task, while simplicity reflects, for example, the number of possible data fields/actions a user has to fill/perform to execute a defined functional task in the application. Overall complexity is often a delicate balance between navigability and simplicity. Attempting to improve navigability, by reducing the number of panels to navigate through, has the consequence of worsening its simplicity; in other words, it becomes harder for the user to identify necessary actions on a given panel, as it becomes increasingly overloaded with options.

There are several problems facing architects, developers and testers of user interfaces. For example, although significant effort is conventionally spent in testing an application's core functionality, the user interface traditionally receives less attention and is treated subjectively rather than undergoing objective analysis. This is surprising given the recognition of its importance, but may reflect a lack of tooling and unbiased approaches. Furthermore, it has been appreciated that a new user's first impression is typically gained through exercising core (“Golden Path”) tasks, and thus that it is important to ensure that such tasks are the simplest, even at the possible expense of increased complexity for less-frequently used “advanced” tasks.

### SUMMARY OF THE INVENTION

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, an application on a graphical user interface (GUI) provided on a display screen of a computer system is presented. The application includes a digitized character for driving a conversation to gather data. In addition, the application includes a user profile for interacting with the digitized character to maintain the conversation. The conversation occurs through chat bubbles and when needed, additional input controls are provided for the data gathering.

In accordance with another aspect of the present application, a graphical user interface (GUI) for use with a browser on a computer is presented. The GUI includes a web page capable of being displayed on the browser of the computer. The web page includes a character image that displays a set of questions and a user icon that responds to the set of questions through input from the browser so that the computer can determine information from the provided responses.

In accordance with yet another aspect of the present application, a mobile device is presented. The mobile device includes a display having touch screen capabilities, a graphical user interface (GUI) provided on the display, at least one processor, and a memory operatively coupled to the processor. The memory stores program instructions, that when executed by the processor, causes the processor to display a digitized character and a user profile on the GUI. The digitized character provides a set of questions to the user profile. The user profile responds to the set of questions answered through a user by the GUI.

In accordance with another aspect of the present application, a computer-implemented method for retrieving information from a user using an application displayed on a graphical user interface (GUI) that facilitates conversations between the computer, taking on a form of a digital character, and the user, taking on a form of a user profile, within the application. The application includes chat bubbles between the digital character and the user profile to obtain information. The chat bubbles provide a conversation that can be read from top to bottom on the GUI with new chat bubbles appearing at the bottom of the GUI. The chat bubbles are capable of being edited on the GUI and can expand in both width and height to accommodate text entered into the chat bubbles.

In addition, the application includes input controls associated with the chat bubbles for the user to enter in information about the item. The input controls include single selection controls for allowing the user to enter in required and optional information. The single selection controls provide scrolling animation, the scrolling animation characterized by having a garage door effect. In addition, the input controls include multi-selection controls allowing the user to enter in more than one value for the information about the item. Furthermore, the input controls include numeric controls allowing the user to enter in amounts, wherein the numeric controls include a slider bar, value indicator, and manual entry. The input controls also include text entry controls allowing the user to enter in text. The text entry controls expand in both width and height to accommodate entered text.

In accordance with still yet another aspect of the present application, a method for interactive data gathering using a conversational interface having visual representations on a wireless device having a display screen and a graphical user interface (GUI) is presented. The method includes parsing and rendering an extensible markup language (XML) document, which when parsed and rendered, the GUI providing a two-way dialogue between a digital character and a user of the wireless device to obtain information about an item. The two-way dialogue is similar to short text message services (SMS).

The two-way dialogue includes chat bubbles between the digital character and the user to obtain information about the item. The chat bubbles provide a conversation that can be read from top to bottom on the GUI with new chat bubbles appearing at the bottom of the GUI. The chat bubbles are capable of being edited on the GUI and can expand in both width and height to accommodate text entered into the chat bubbles.

In addition, the two-way dialogue includes input controls associated with the chat bubbles for the user to enter in information about the item. The input controls includes single selection controls for allowing the user to enter in required and optional information, wherein the single selection controls provide scrolling animation, the scrolling animation characterized by having a garage door effect. In addition, the input controls include multi-selection controls which allow the user to enter in more than one value for the information about the item. Furthermore, the input controls include numeric controls allowing the user to enter in amounts, wherein the numeric controls include a slider bar, value indicator, and manual entry. The input controls also include text entry controls allowing the user to enter in text, wherein the text entry controls expand in both width and height to accommodate entered text. The input controls include physical dimension controls allowing the user to enter in dimensions for packing the item. The input controls include pricing selection controls which allow the user to enter in the minimum amount the user is willing to accept for the item, enter in a price the user wants to sell the item for, and enter in an amount the user paid for the item.

Continuing with the present aspect, the method further includes sending a request to the online marketplace management system to retrieve pricing data for the item based on the information obtained from the two-way dialogue. In addition, the method includes generating a price/value chart based on the pricing data received from the online marketplace management system and displaying the chart on price/value the GUI to the user. Furthermore, the method includes allowing the user to enter in a price for the item and review the information about the item and sending the information, including the price, for the item to the online marketplace management system. The online marketplace management system posts the information about the item so that buyers can purchase the item by viewing the information entered in by the user using the GUI.

In accordance with another aspect of the present application, a computer readable medium storing instructions for causing at least one processor to perform the methods provided above is presented.

### BRIEF DESCRIPTION OF ATTACHMENTS

ATTACHMENT A (19 Pages) titled “Zuujit Application UI—Conversation Interface” discloses details of the chat interface, otherwise known as “Kim”. ATTACHMENT A provides useful information on the user interface as well as the Script XML technology that drives it. Furthermore, multiple features along with exemplary pictorial representations are described therein. ATTACHMENT A is hereby incorporated by reference in its entirety, including, any appendices, screen shots, and references thereto.

ATTACHMENT B (8 Pages) titled “Zuujit Server API Call Flow” discloses the sequence of server API calls within the context of the iPhone Sell

Application presented herein. ATTACHMENT B is hereby incorporated by reference in its entirety, including, any appendices, screen shots, and references thereto.

ATTACHMENT C (7 Pages) titled “Zuujit Script XML Changes” provides changes required in the script XML to generalize the user interface at all levels of the Sell Application. ATTACHMENT C is hereby incorporated by reference in its entirety, including, any appendices, screen shots, and references thereto.

ATTACHMENT D (12 Pages) titled “Zuujit Screen Analysis” provides a description of the customized controls presented herein. The customize controls not only provide functional aspects to the Sell Application, but also incorporate sophisticated new looks for gathering data. ATTACHMENT D is hereby incorporated by reference in its entirety, including, any appendices, screen shots, and references thereto.

ATTACHMENT E (6 Pages) titled “Zuujit New Flow for UploadMedia” provides a new implementation for the UploadMedia functionality. ATTACHMENT E is hereby incorporated by reference in its entirety, including, any appendices, screen shots, and references thereto.

ATTACHMENT F (28 Pages) titled “Zuujit Application Architecture” describes the architecture for Zuujit's new iPhone application. The application is a client server application that uses HTTPS POST as a communication protocol. ATTACHMENT F is hereby incorporated by reference in its entirety, including, any appendices, screen shots, and references thereto.

ATTACHMENT G (5 Pages) titled “Zuujit Script Player Edit Operation” describes the edit operation used within the script player. ATTACHMENT G is hereby incorporated by reference in its entirety, including, any appendices, screen shots, and references thereto.

ATTACHMENT H (8 Pages) titled “Zuujit Script Interpreter Implementation” describes the implementation used for the Script Interpreter for the iPhone Sell Application. The Sell Application would use the script player to capture all required input from the user and capture values used by the Zuujit Server to initiate new listings on eBay or other online marketplace. ATTACHMENT H is hereby incorporated by reference in its entirety, including, any appendices, screen shots, and references thereto.

ATTACHMENT I (6 Pages) titled “Zuujit Application UI—Image Flow and Camera Interface” describes several flow diagrams in the form of images for the Zuujit Sell Application. There are two main functionalities of the image flow: using the camera to take a new image, and browsing through the photo library of the device to choose an existing image. ATTACHMENT I is hereby incorporated by reference in its entirety, including, any appendices, screen shots, and references thereto.

ATTACHMENT J (6 Pages) titled “Zuujit Application UI—Listing Management Interface” describes the listing management interface. The interface allows a user to access their active, sold, and saved listings and obtain current information about each. The interface is divided into six sections: the main page, listing status, messages, listing details, offer management, and sold listing management. ATTACHMENT J is hereby incorporated by reference in its entirety, including, any appendices, screen shots, and references thereto.

### BRIEF DESCRIPTION OF THE DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1A is a block diagram showing an exemplary architecture depicting elements contained within an illustrative remote wireless device in accordance with one aspect of the present application;

FIG. 1B is a block diagram showing an exemplary architecture for interaction between the remote wireless device, the service system and the sales listing system in accordance with one aspect of the invention;

FIG. 2A is a block diagram depicting an illustrative registration process in accordance with one aspect of the present application;

FIG. 2B is a block diagram depicting an illustrative account creation and selection process in accordance with one aspect of the present application;

FIG. 3A is a block diagram depicting an illustrative listing process in accordance with one aspect of a first embodiment of the present application;

FIG. 3B is a block diagram depicting an illustrative service system server companion processes for listing items in accordance with one aspect of a first embodiment of the present application;

FIGS. 3C, 3D and 3E are block diagrams depicting an illustrative listing process in accordance with a second embodiment of the present application with interactive service system server companion processes;

FIG. 4 is a block diagram illustrating an exemplary post sale process in accordance with one aspect of the present application;

FIGS. 5A through 5I are exemplary implementations of the illustrative system on a PDA or cell phone for the listing process including data entry and imaging in accordance with one aspect of the present application;

FIGS. 6A through 6C are exemplary implementations of the illustrative system on a PDA or cell phone for account maintenance and review in accordance with one aspect of the present application;

FIGS. 7A and 7B are exemplary implementations of the illustrative system of the PDA or cell phone for post sale shipment and other general functions in accordance with one aspect of the present application;

FIG. 8 depicts an exemplary networked environment in which an illustrative wireless device may be used in accordance with one aspect of the present application;

FIG. 9 is a schematic view of the illustrative wireless device that may be used to access a network in accordance with one aspect of the present application;

FIG. 10 is an illustrative hardware diagram of the exemplary wireless device in accordance with one aspect of the present application;

FIG. 11 provides a standard conversation window displayed on a wireless device in accordance with one aspect of the present application;

FIG. 12 illustrates transitions within the standard conversation window displayed on the wireless device in accordance with one aspect of the present application;

FIG. 13 shows a typical sequence of routines used for hiding input controls on the standard conversation window displayed on the wireless device in accordance with one aspect of the present application;

FIG. 14 shows illustrative single selection input controls on the standard conversation window displayed on the wireless device in accordance with one aspect of the present application;

FIG. 15 shows illustrative optional single selection input controls on the standard conversation window displayed on the wireless device in accordance with one aspect of the present application;

FIG. 16 shows illustrative multi selection input controls on the standard conversation window displayed on the wireless device in accordance with one aspect of the present application;

FIG. 17 shows illustrative numeric input controls on the standard conversation window displayed on the wireless device in accordance with one aspect of the present application;

FIG. 18 shows illustrative manual entry input controls on the standard conversation window displayed on the wireless device in accordance with one aspect of the present application;

FIG. 19 shows illustrative slider value input controls on the standard conversation window displayed on the wireless device in accordance with one aspect of the present application;

FIG. 20 shows illustrative physical dimension input controls on the standard conversation window displayed on the wireless device in accordance with one aspect of the present application;

FIG. 21 shows illustrative pricing selection input controls on the standard conversation window displayed on the wireless device in accordance with one aspect of the present application;

FIG. 22 depicts an illustrative text input control on the standard conversation window displayed on the wireless device in accordance with one aspect of the present application;

FIG. 23 depicts an illustrative text input control on the standard conversation window displayed on the wireless device when the entered text expands beyond the single line of the text input control in accordance with one aspect of the present application;

FIG. 24 shows illustrative price/value charts displayed on the wireless device in accordance with one aspect of the present application;

FIG. 25 provides an exemplary review screen displayed on the wireless device in accordance with one aspect of the present application;

FIG. 26 illustrates an exemplary generated title displayed on the wireless device in accordance with one aspect of the present application;

FIG. 27 shows an exemplary generated pricing value on the wireless device in accordance with one aspect of the present application;

FIG. 28A is an illustrative flow chart describing the login procedure for the Sell Application in accordance with one aspect of the present application;

FIG. 28B is an illustrative flow chart describing the new listing procedure for the Sell Application in accordance with one aspect of the present application;

FIG. 28C is an illustrative flow chart describing the post listing procedure for the Sell Application in accordance with one aspect of the present application;

FIG. 28D is an illustrative flow chart describing the active or sold listing procedure for the Sell Application in accordance with one aspect of the present application;

FIG. 29 is an illustrative flow chart describing the upload media procedure for the Sell Application in accordance with one aspect of the present application; and

FIG. 30 is an illustrative flow chart describing the no connectivity procedure for the Sell Application in accordance with one aspect of the present application.

### DEFINITIONS

Definitions for terms used throughout this application are provided below. While the language defining the definitions are intended to enable one skilled in the relevant art to understand the complexity of the present application, the terms, as defined, should not be construed as limiting to its scope.

The term wireless device can refer to any computing device that has a display screen with a touch input or a keyboard. The term can be interchanged with cell phone, handheld device, handheld computer, “Palmtop”, Smartphones, iPhone, Blackberry, or handheld. Personal digital assistants (PDAs) can also be a wireless device. In a PDA, the inputs and outputs are combined into a touch-screen interface. Smartphones can include a conventional computer.

While the present application relates to wireless devices, one skilled in the relevant art will appreciate that the user interface described herein can be implemented on a desktop computer, laptop, or any other device that has a display screen, including a monitor associated with a television.

### DESCRIPTION OF THE PREFERRED EMBODIMENT(S)

The description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

System Overview

Generally described, this provisional application relates to data gathering through a user interface, and more particularly, to an interactive application for a user to communicate with their wireless device that implements a two-way dialogue between a digital character and a user profile operated by the user, the conversation driven by an XML based document and having behavior identical to short message services. In one illustrative embodiment, the user interface includes chat bubbles between the digital character and the user profile to obtain information from the user. The chat bubbles provide a conversation that can be read on a graphical user interface (GUI). Generally, the chat bubbles are provided in a question/answer format.

Associated with the chat bubbles are input controls, the input controls allow the user to enter in information. The user interface provides single selection controls for allowing the user to enter in required and optional information. The single selection controls provide scrolling animation, the scrolling animation characterized by having a garage door effect. Multi-selection controls allowing the user to enter in more than one value about the item are also provided. The user interface provides numeric controls that allow the user to enter in amounts. The numeric controls include a slider bar, value indicator, and manual entry. Text entry controls allowing the user to enter in text are also provided. The text entry controls expand in both width and height to accommodate entered text. The user interface provides physical dimension controls that allow the user to enter in dimensions for packing the item. Pricing selection controls which allow the user to enter in the minimum amount the user is willing to accept for the item, enter in a price the user wants to sell the item for, and enter in an amount the user paid for the item are further provided.

The user interface presented herein can provide an interactive way for a user to buy or sell items using their wireless device, such as an iPhone, Blackberry. Nonetheless, the scope of the present application should not be limited to such. Accordingly, the user interface can be applied to other applications. In one example, the user interface can be applied to data collection. Alternatively, the user interface can simply be used for its chat bubbles. One skilled in the relevant art will appreciate that the user interface can be used by any application or program that requests input and displays output.

Continuation-In-Part

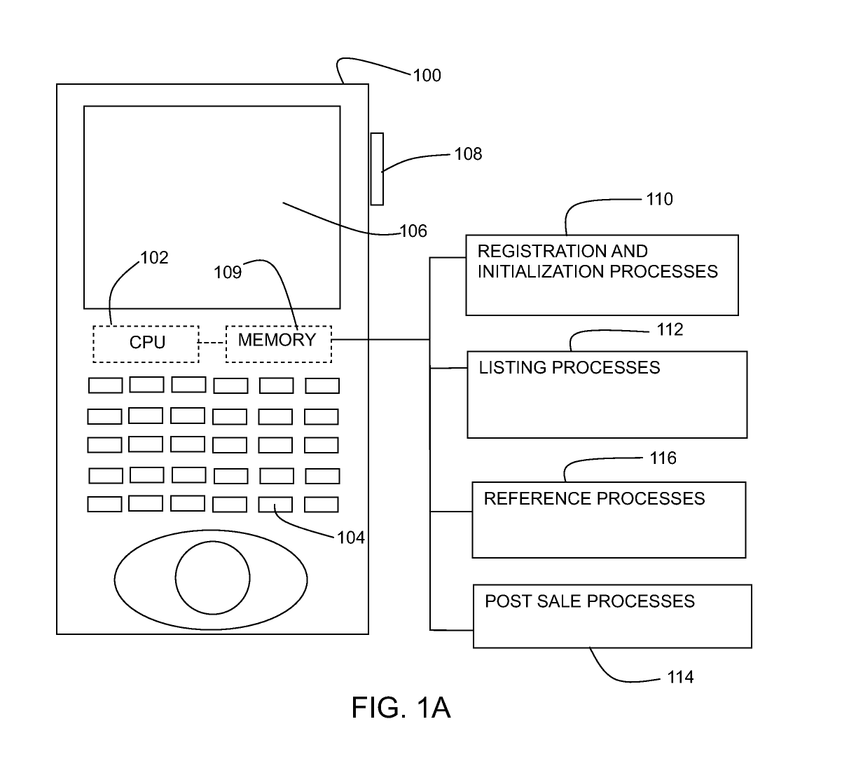

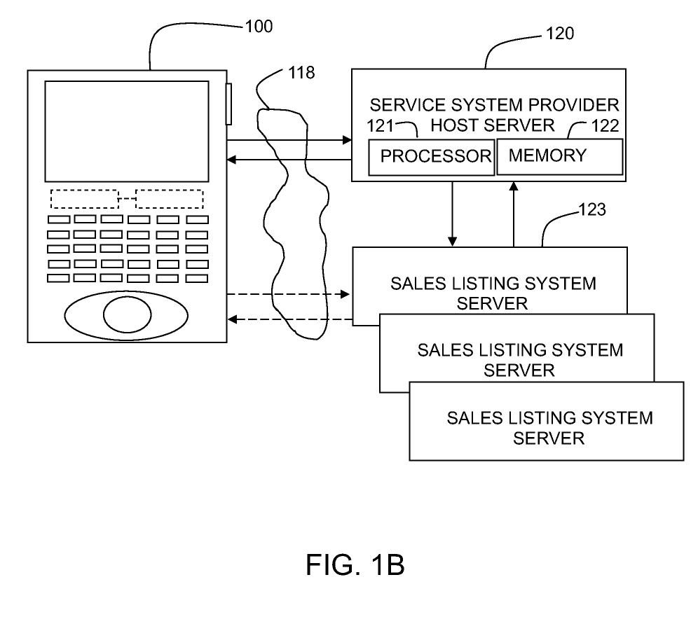

For purposes of clarity, the non-provisional application to which this provisional application claims priority to is hereinafter substantially repeated. The previous application incorporated a wireless device as shown in FIG. 1A such as a cellular phone or PDA 100 having an integral central processing unit (CPU) 102, an input keyboard 104, display 106 and an integrated camera 108. An operating memory 109 interacts with the CPU and incorporates multiple processing modules including a Registration and Installation Process 110 for installing components of the system on the PDA 100, a Listing Process 112 for employing the PDA within the installed system and integrated camera for entering the sales details of an item and communication with the selling agency for transmission/verification of the sales details and a Post Sale Process 114 for transaction notification and completion. Embodiments of the application as implemented include additional functions for preference settings and reference processes 116 associated with the PDA operation for listing development and communication with the selling agency.

As shown in FIG. 1B, the PDA communicates over a network 118 with a provider host server 120 for a service system that provides downloads of the various modules to the PDA. The server incorporates processor 121 and a memory 122 or other storage capability. In certain embodiments, the provider host servers interface with servers 123 of a sales listing system for actual communication of listings. In alternative embodiments, the PDA communicates directly with the sales listing system servers for actual listing of the item for sale.

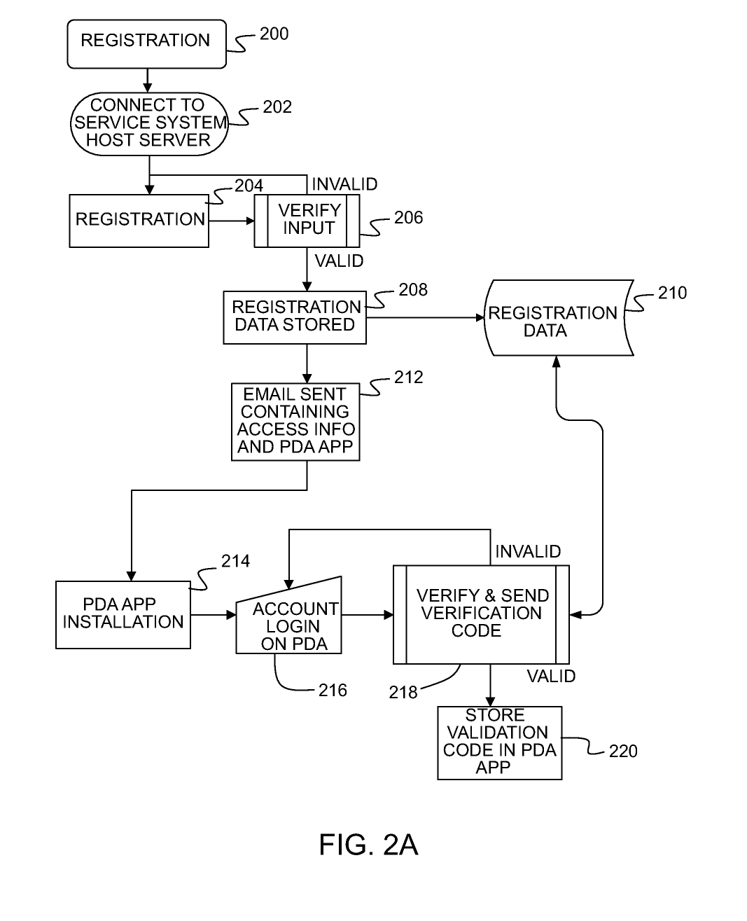

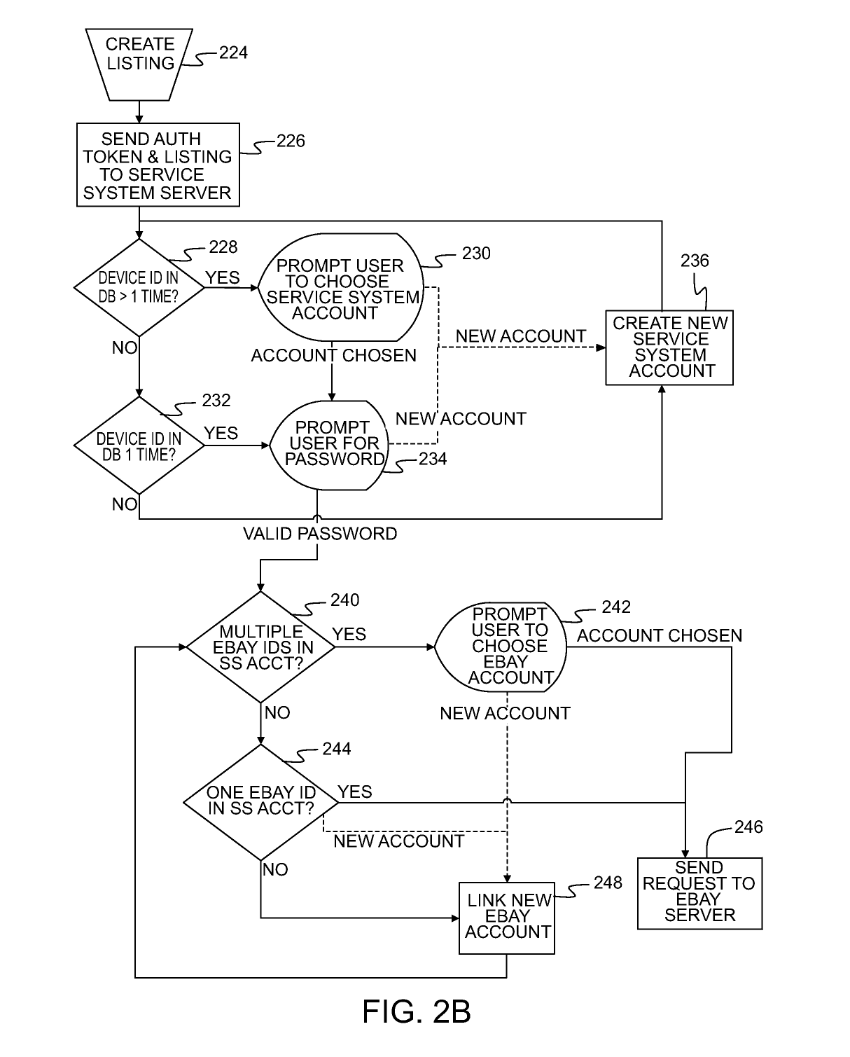

Referring to FIG. 2A, the Registration and Installation Process 110 includes downloading of interactive modules to the PDA 100 through a wireless web connection from a service system provider, entry of registration data for the user via the web connection to the service system servers and an activation process for installation of the interactive modules. The registration process begins at block 200. At block 202, a PDA 100, equipped for incorporating the modules described above, is wirelessly connected to a host server for the service system, and registration information is transmitted to the server at block 204 with the server verifying the input at block 206. If invalid input is received, an appropriate message is returned to the PDA and the system returns to block 204 for transmission of registration information. A valid input results in storage of the PDA data at block 208 in a database 210 associated with the service system. An e-mail or similar type of communication is sent by the service system server at block 212 providing access information and the downloadable application software for the system modules. The downloaded application is installed on the PDA at block 214 and the PDA is then enabled for account login at block 216. Upon logging-in to the host, the host will verify the PDA data and application modules and if valid, will provide a validation code at block 218 to be stored in the PDA for future use at block 220. The registration and installation process is then complete. If an invalid input is received upon account login, the host will respond with an error message and return to block 222 for account login.

In addition to initial registration and downloading of the software system to the PDA, FIG. 2B demonstrates an exemplary process for registration of accounts in the system. Upon entering the system to create a listing at block 224, the PDA sends an authorization token and listing request to the server at block 226. The server determines if a device ID exists in the service system database (DB) at more than one location at decision block 228. If so, the user is prompted on the PDA display to choose the appropriate account relating to that device ID at block 230. If the device ID only exists once in the service system database at decision block 232 or upon selection of the desired account, the user is prompted on the PDA display to enter a password at block 234. If the device ID does not exist in the service system database, a new account is created at block 236 as previously described in blocks 218 through 222 of FIG. 2A. Upon entry of a valid password by the user, a determination is made if multiple account IDs for the selected listing service, such as eBay, Amazon, or Craigslist are present at decision block 240. If so, the system directs the PDA to display a prompt for the user to choose one of the accounts at block 242. If multiple account IDs do not exist for the listing service, a determination is made if one ID exists at decision block 244. If one ID exists or upon choice of the desired account by the user responsive to the prompt at block 242, the service system forwards the listing request to the listing server at block 246 (an E-bay server in the drawing example). If no listing service ID is present, a link is created to the listing service for creation of a new account at block 248. At the prompt for either block 242 or block 244 the user has an option of creating a new account.

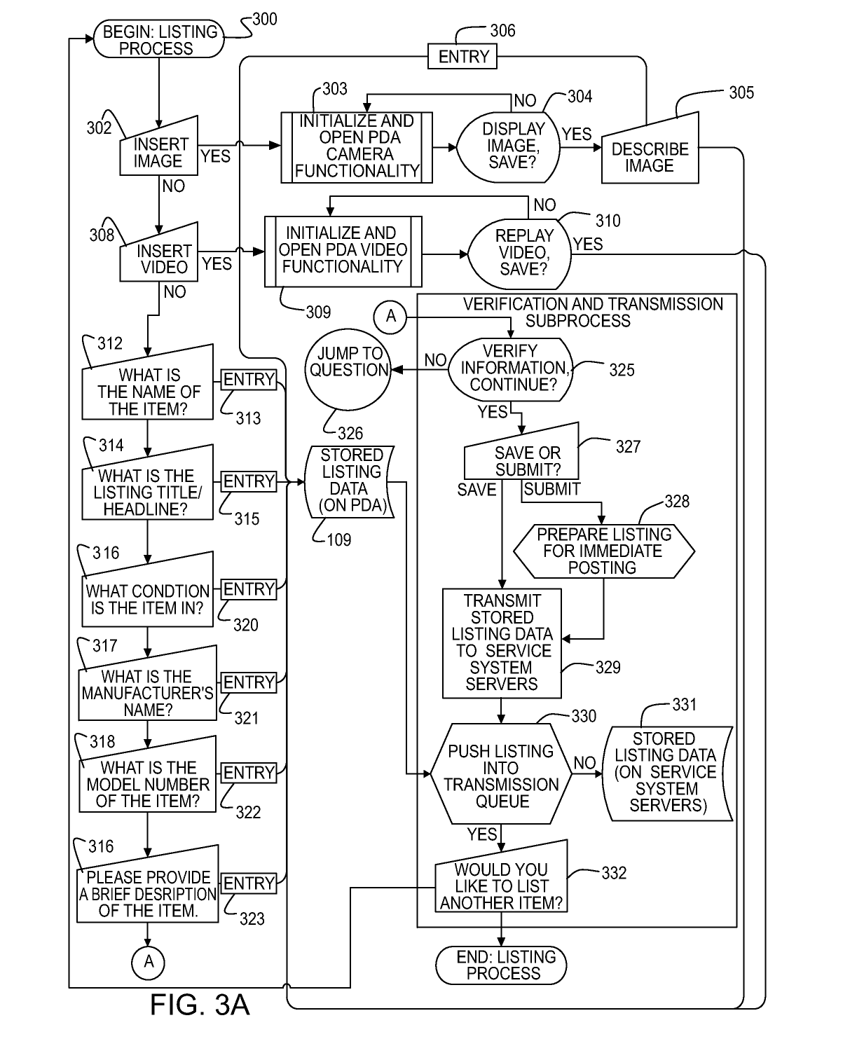

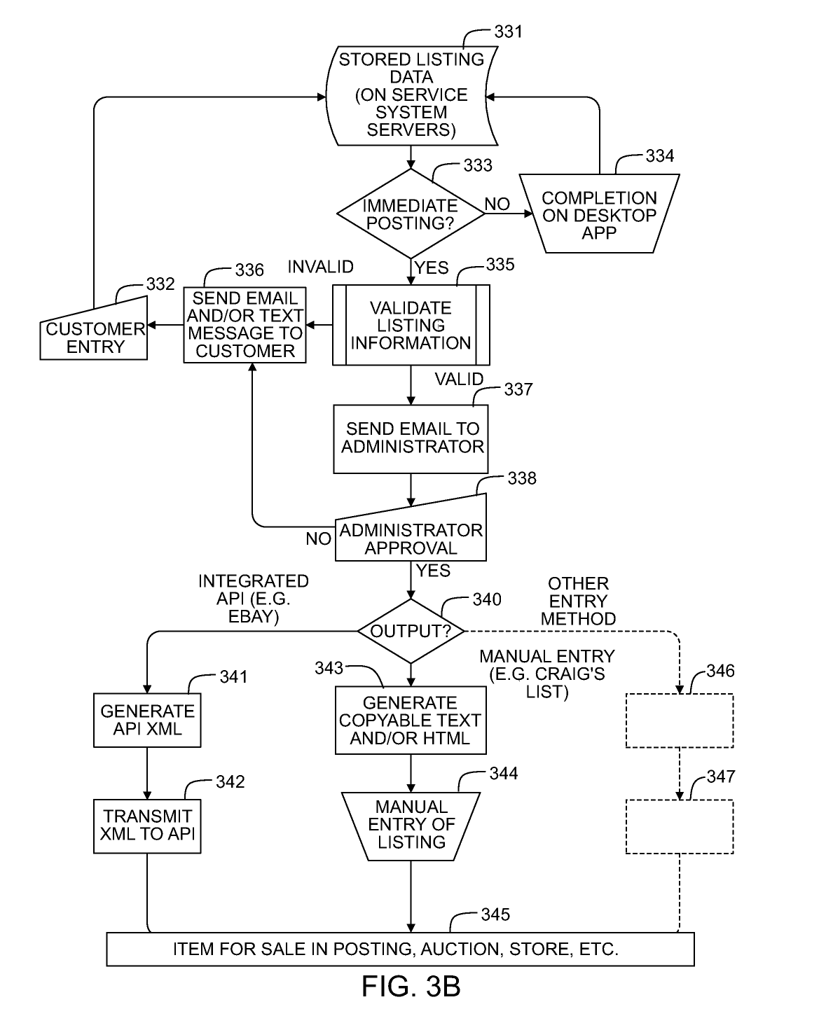

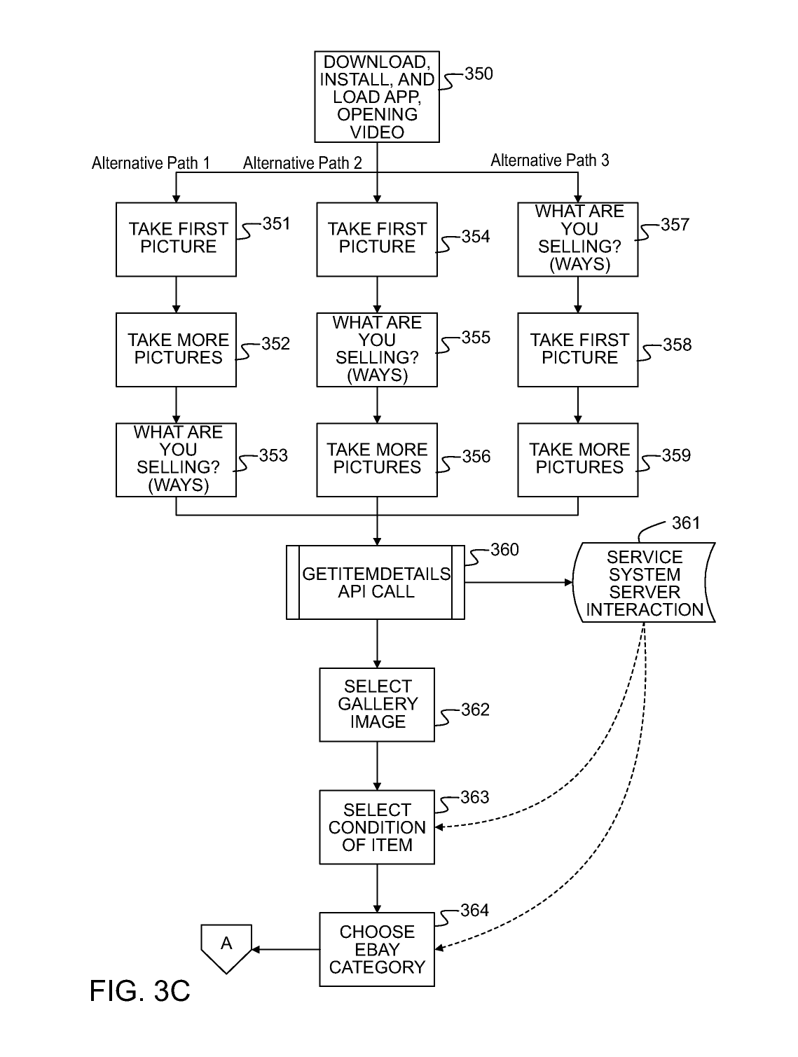

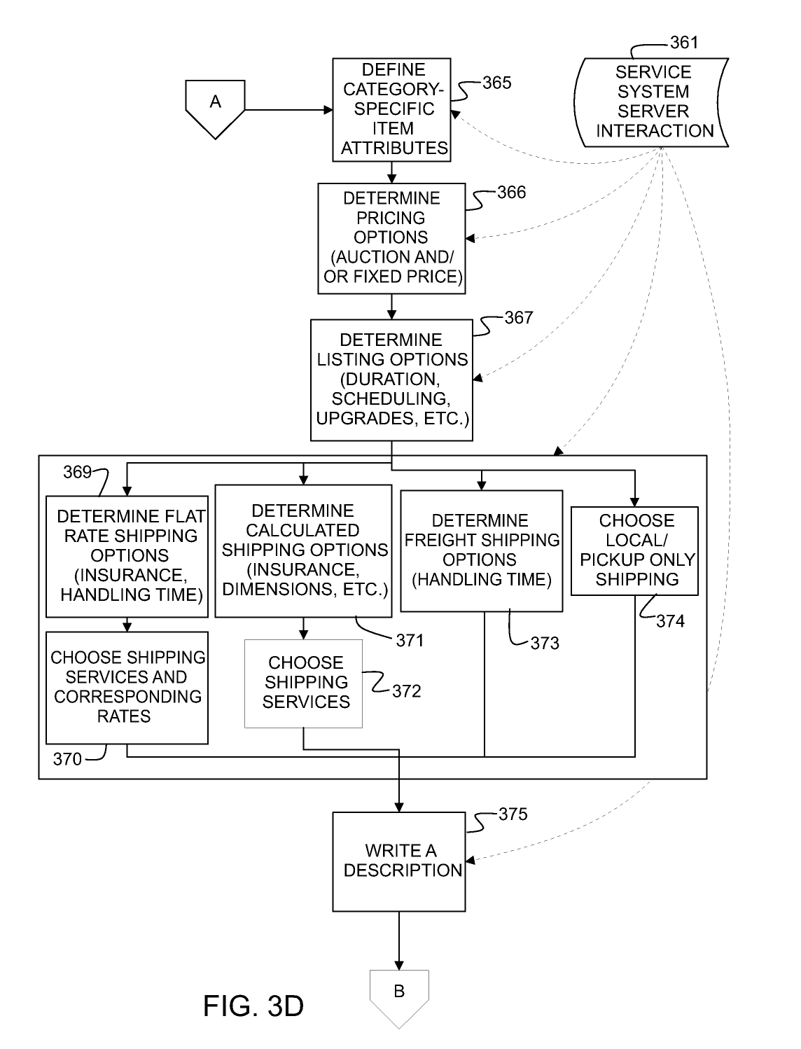

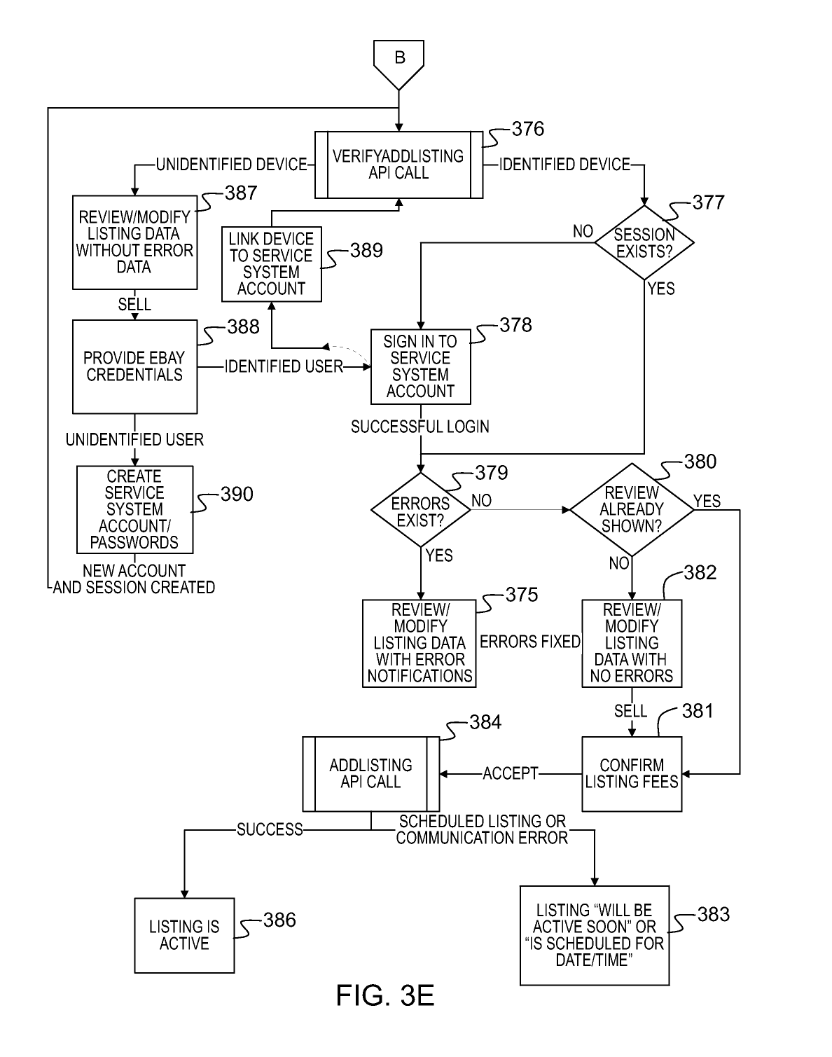

The Listing Process for a first embodiment, shown in detail in FIG. 3A, includes a plurality of routines prompted by the interactive modules on the PDA which can be accomplished prior to entry into the service system server for listing of a sale item to save time and minimize wireless connection time issues. Commencement of the listing process 300 on the PDA is prompted by a request for photo entry at block 302. Using an integrated camera in the PDA or cell phone, the PDA initializes and opens the camera functionality at block 303. The image taken by the user is displayed and a prompt to save the image is provided at block 304. If the image is not sufficient or accepted by the user, the user can select not to save the image and the PDA reverts to the camera mode. If the user saves the image, a prompt is provided for a description of the image at block 305 which is then entered at block 306 on the PDA keypad and a return to the prompt for images is made. Each entry such as block 306 and those subsequently defined are stored on the PDA as listing data as will be described in detail below.

A prompt for video input is then made at block 308 and if selected, the PDA initializes and opens the PDA video functionality at block 309. Upon completion of video input, a prompt for viewing and saving the video is provided at block 310. If not saved, the system reverts to the video input prompt. If saved by entry 311, the data input for the item is stored in the PDA. Multiple items can be prepared for listing and stored on the PDA.

The system then prompts the user for an item name at block 312 which is entered at block 313 using the PDA keypad. A listing title or headline (which can be prompted in a specific format for predetermined sales service providers (i.e. E-bay)) is requested at block 314 and entered at block 315. The item condition at block 316, manufacturer at block 317, model number at block 318 and item description at block 319 are requested with PDA inputs by the user reflected at blocks 320, 321, 322 and 323. Each entry stores data in the memory 109 of the PDA.

A verification and transmission process module at block 324 is activated when the user elects to transmit data to the sales service provider which allows a data review and communicates with the provider (including selection of provider in certain embodiments). A verification routine at block 325 allows the user to scroll through the information input in the listing process and, if a data change is required, allows jumping at branch 326 to the entry question (blocks 312, 314, 316, 317, 318 and 319) for correction/entry. The user is then prompted to save the listing data to the host at the service provider or submit the listing at block 327. The data save to the host allows further processing by the user from a companion desktop application at a personal computer or other network device if more convenient. If a “submit listing” choice is made, the system prepares the listing for immediate posting at block 328. After the listing preparation, or if storage on the service system server has been selected, a transmission module at block 329 is activated. The PDA accomplishes a log-in as previously described with respect to FIG. 2B and the PDA pushes the listing into a transmission queue at block 330 retrieving data from the PDA memory which has received each of the listing inputs. The data for the item is then stored on the service provider host server at block 331.

Companion modules on the service system server receive the item data, perform listing functions and actual listing of the item, and confirm communications to the PDA of the listing and sale monitoring/notification functions. As shown in FIG. 3B, the data stored from the PDA is available on the host server data storage at block 331. If the host determines that immediate posting was not selected by the user at block 333, the host module makes the data available for interaction with a PC or other network terminal available to the user for completion of the listing at block 334. If posting has been directed, the host validates the listing information at block 335, and if invalid, generates an e-mail and/or text message to the user at block 336, which is received by the PDA. User input from the PDA through the verification routine previously described provides revised data in the stored data listing for processing. A valid listing results in an a-mail or similar type of communication to the service system server administrator at block 337 for approval of the posting at block 338. If posting is not approved, the service system server reverts to block 336 sending an e-mail or similar type of notification to the user. If the posting is approved, an output will be made at block 340, and a service provider host with an integrated API will generate an appropriate XML for the API at block 341 and transmit the XML to the API for operation at block 342. Alternatively, the service provider administrator will generate copyable text and/or HTML at block 343 and provide manual entry of the listing at block 344. The item posted will then be shown in the service providers, posting, auction or store at block 345. Alternative listing service data entry protocols represented generically as blocks 346 and 347 can be accommodated.

An alternative embodiment for the listing process is shown in FIGS. 3C through 3E. The software download, installation and initiation at block 350 is accomplished as previously described. Upon opening the listing application on the PDA three optional paths are available to the user. In the first alternative path, a prompt is provided on the screen requesting the user to take a first picture. Upon entry of the image at block 351, a prompt is provided on the screen for additional pictures. If the user takes additional pictures, images are entered at block 352, and a prompt is provided on the screen for “what are you selling” (WAYS) with entry of an item title by the user at block 353. In the second alternative path entry of a first image, block 354 results in a prompt for WAYS with entry of an item title by the user, block 355. A prompt is then provided on the screen for additional pictures and additional images are entered at block 356. In the third alternative, the WAYS is prompted on the screen and entered by the user at block 357. A prompt for a first picture is then provided with entry of the image taken by the user at block 358. A prompt for additional pictures is provided on the screen and, if the user takes additional pictures, images are entered at block 359.

The PDA then establishes wireless contact with the service system provider host at block 360 to commence the listing interaction. The service system provides interactive analysis and processing of the various listing input parameters to provide automated assistance where applicable at block 361. A gallery of the images entered for the listing is then presented to the user and a selection of the desired image is made at block 362. A prompt is then provided to select the condition of the item and a condition entered or selected by the user is stored at block 363. A prompt is then provided to select a category for the listed item consistent with the listing service to be used and the chosen category is entered at block 364.

A prompt is then made to define category specific item attributes which are then entered as defined by the user at block 365. Based on the listing service to be used, a determination of pricing options, such as auction or fixed-price, is made at block 366, and listing options such as the duration of the auction, scheduling time for the auction and other listing service features are determined at block 367. For listing services where multiple shipping options are provided, screen prompts and data entry are accomplished, generally designated at block 368. For an exemplary listing service, a determination is made regarding flat rate shipping options such as insurance and handling time at block 369 and the shipping services and corresponding rates are then chosen at block 370. As a first alternative calculated shipping options are determined at block 371, and the appropriate shipping service is chosen at block 372. As a second alternative a determination is made regarding freight shipping options at block 373, and in the fourth alternative local pickup is selected at block 374.

A description is then written for the listed item at block 375 which incorporates the information entered in the interactive listing process on the PDA as set forth above. The description can be a compilation of the entries as entered or can be tailored by interactive operation with the service system's server. A review of the description by the user interactive alteration of the various inputs or recommendations can then be accomplished.

As a continuation of the listing process, or as a subsequent wireless contact, the PDA calls the service system provider host for verification of the ad listing at block 376. If upon the call the provider host recognizes the PDA as an identified device, a determination is made if a wireless session exists at block 377. If a session does not exist signing in to the service system account at block 378 is accomplished as previously described. Upon a successful log in or if a prior session did exist, a determination is made if errors in the listing are present at block 379. A determination is then made if a review of the listing by the user has been made on the PDA at block 380. If the listing has been reviewed by the user, a confirmation of listing fees to be charged by the sales listing service is made at block 381.

If the user has not yet reviewed the listing, data for the review is provided on the PDA screen at block 382, and if no errors are identified or changes made by the user as designated by a “sell” instruction, the listing fees are then confirmed. Similarly, if errors do exist in the listing as detected by the provider host, listing data for a review with error notifications is presented to the user at block 383. Entries by the user to fix the identified errors results in presentation of the listing data as previously defined for block 382.

Upon acceptance of the listing fees the provider host issues a listing call to the listing service server at block 384. A successful interaction between the provider host server and the listing service server results in an active listing at block 385. If the listing is subsequently to be scheduled or a communications error occurs between the service provider host and listing service server, notification is provided to the user on the PDA screen at block 386.

If the device is unidentified during the verify add listing call of block 376, a data review for the listing is presented at block 387, and upon a sell command from the user listing, service credentials are provided at block 388. An identified user is then signed into the service system account as previously defined in block 376 and the device is linked to the service system account at block 389. If the user remains unidentified, a service system account is created at block 390, and the new account and session are created.

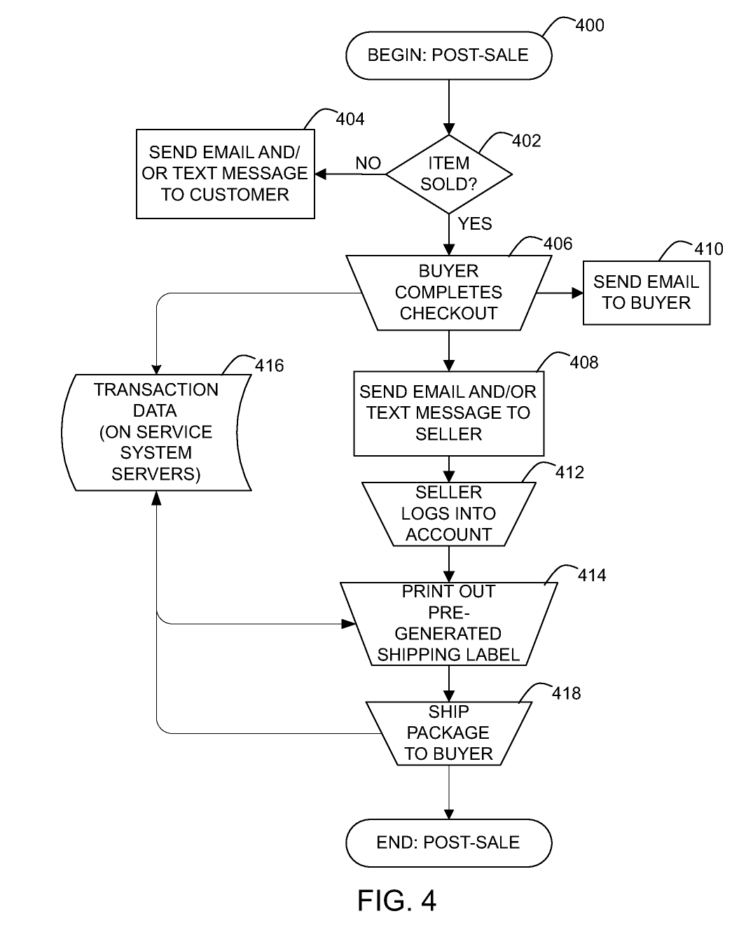

The Post Sale Process 400 shown in FIG. 4 employs the companion modules at the service provider host to monitor the posting for sale at block 402. If the item is not sold, the host sends a text message or email notification to the PDA notifying the user at block 404. If the item is sold, and the buyer completes the internal checkout processes of the provider at block 406, the host sends a text message or email notification to the PDA of the sale at block 408. Standard host processing for notification of the buyer through e-mail is also accomplished at block 410 and the transaction data for delivery is stored at the host at block 412. Upon receipt of the “sale” message, the PDA system then provides automated interactive modules to the user to log into the account at block 412 for shipping instructions and printing out a pre-generated shipping label at block 414 through interaction with the transaction data at block 416 saved on the host data storage system. Upon shipment of the package to the buyer, the PDA system is used to transmit a shipment notice at block 418 to the host for storage on the host data system and post sale requirements.

A system employing the previous application is compatible with advanced PDAs and cellular phones which preferably provide, as described previously with respect to FIG. 1A, a touch sensitive screen 106 and standard cursor controls 107 for manipulating data on the screen. A keypad 104 for data entry provides input for the various text elements required by the system. In alternative embodiments, use of stylus written input using systems such as Palm® Graffiti or a keyboard image on the screen and with touch activation can be employed.

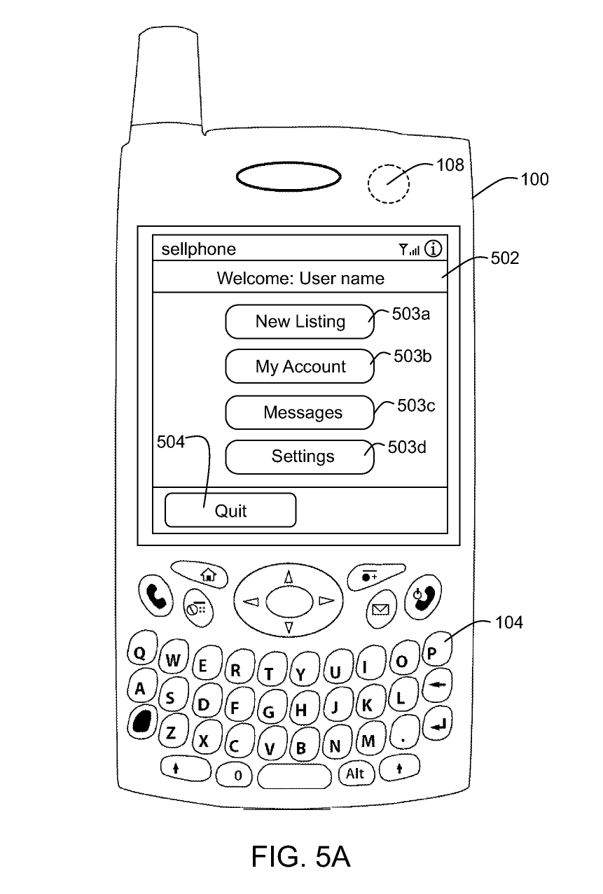

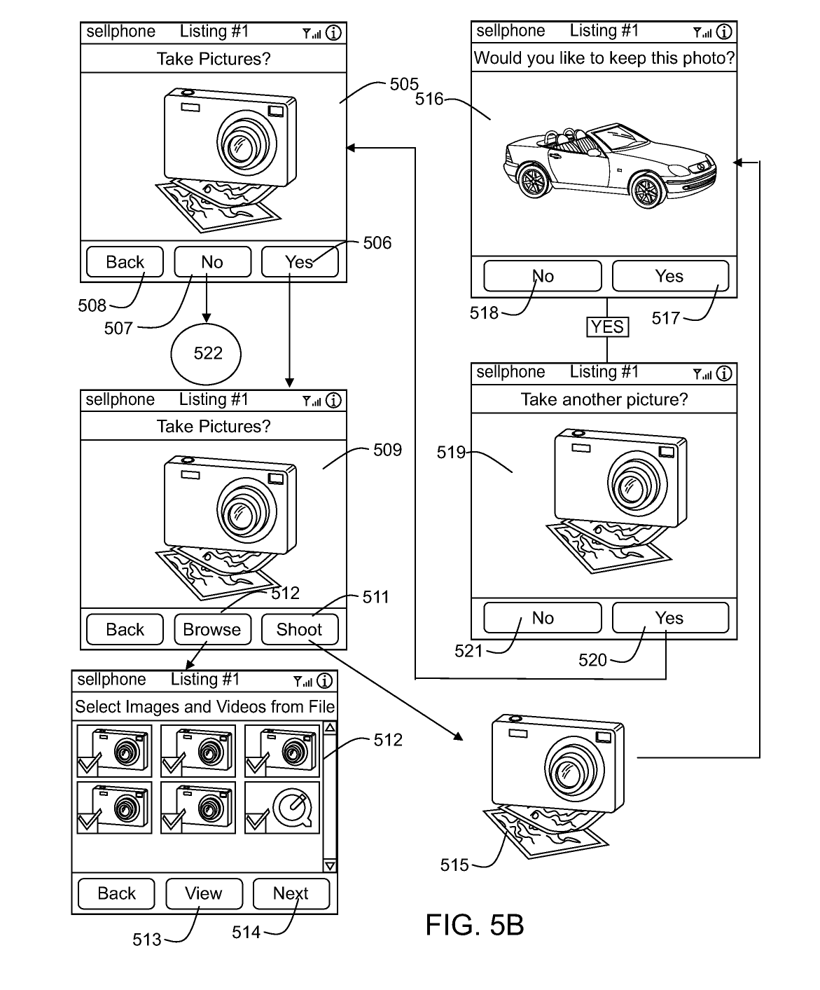

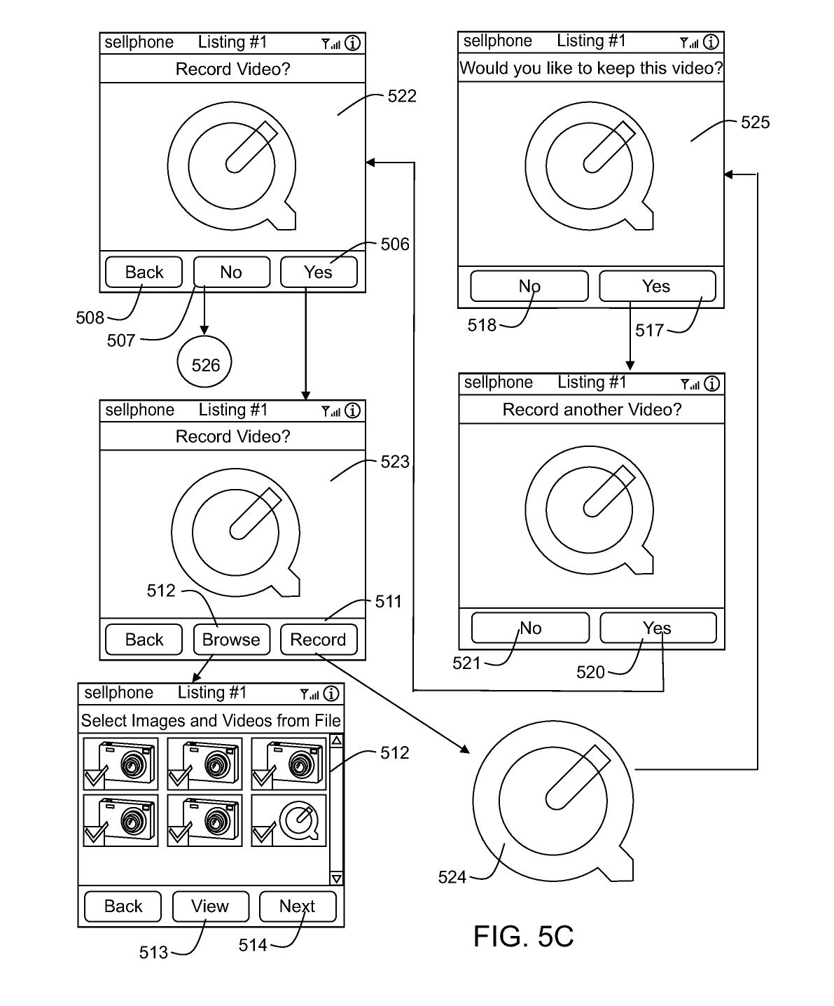

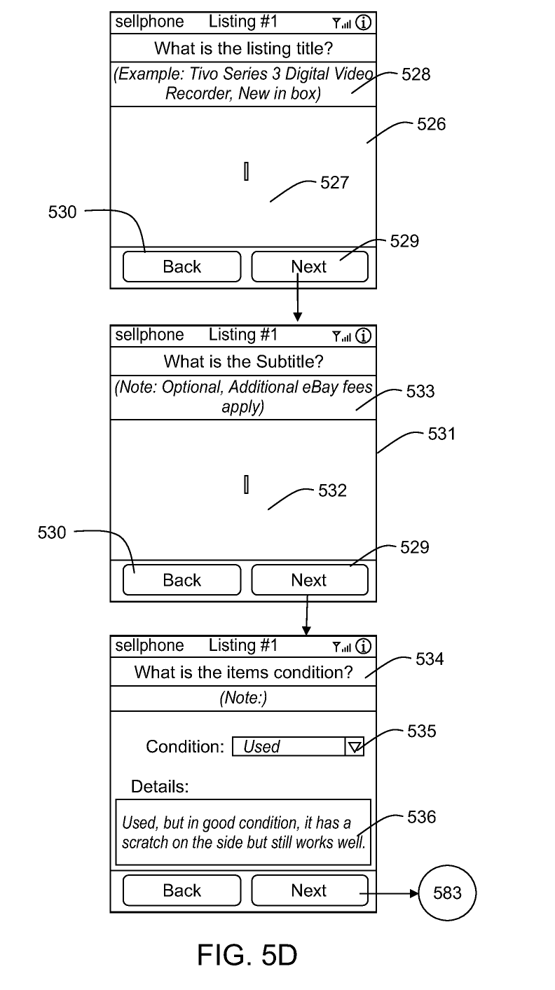

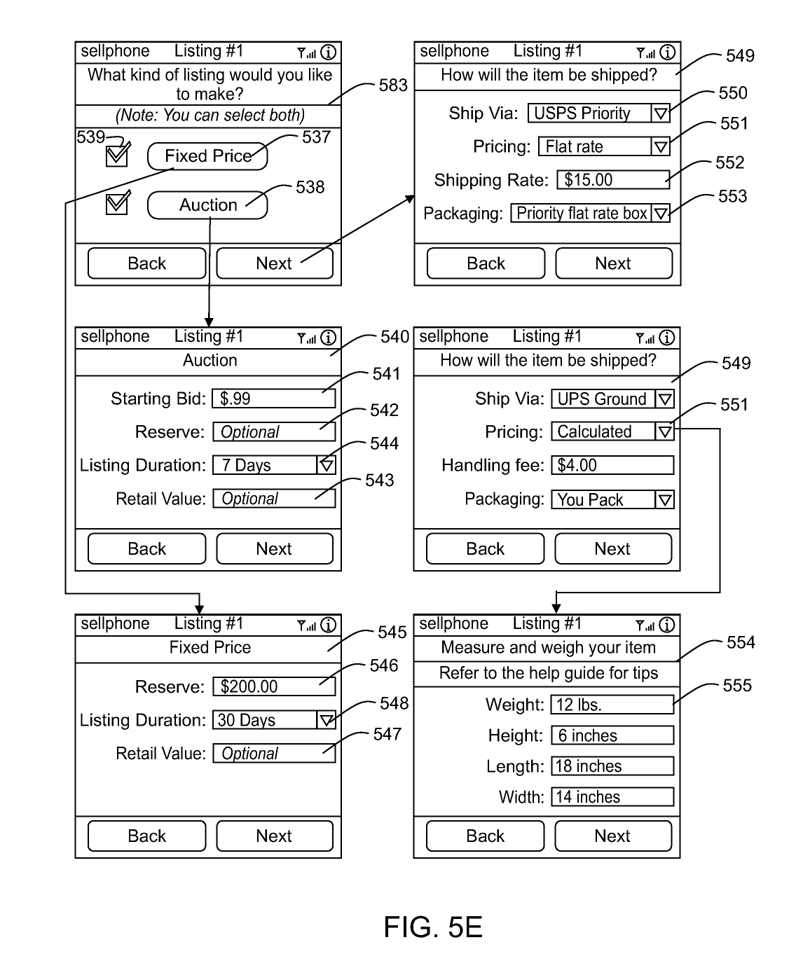

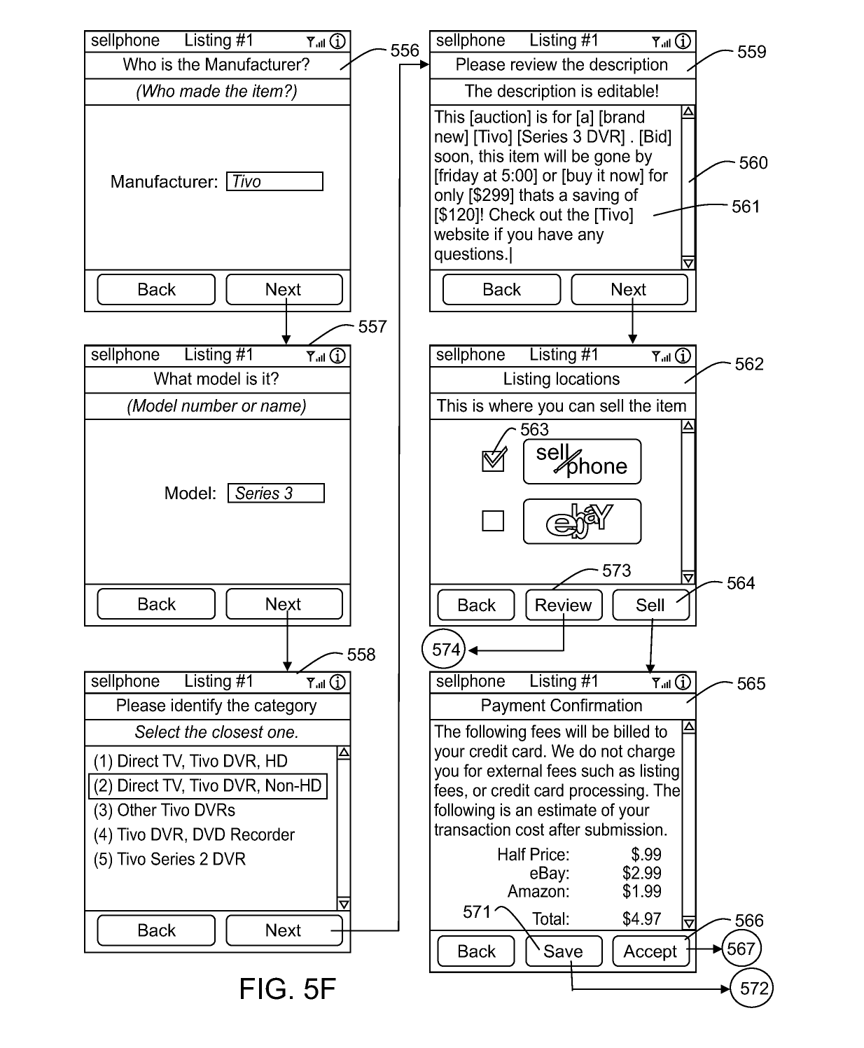

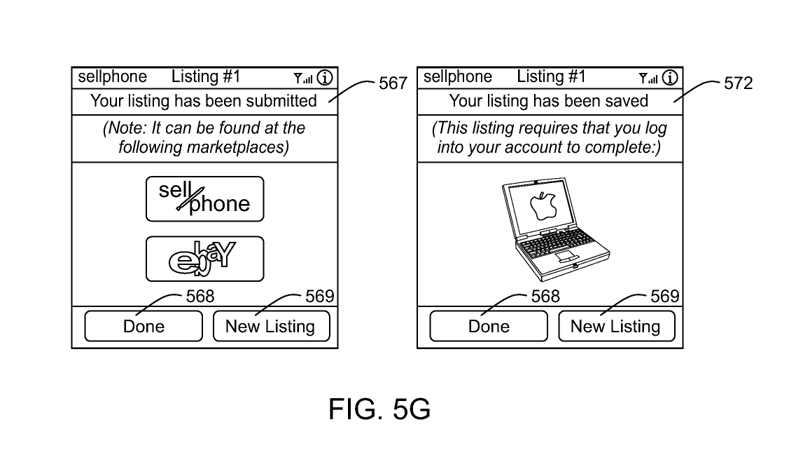

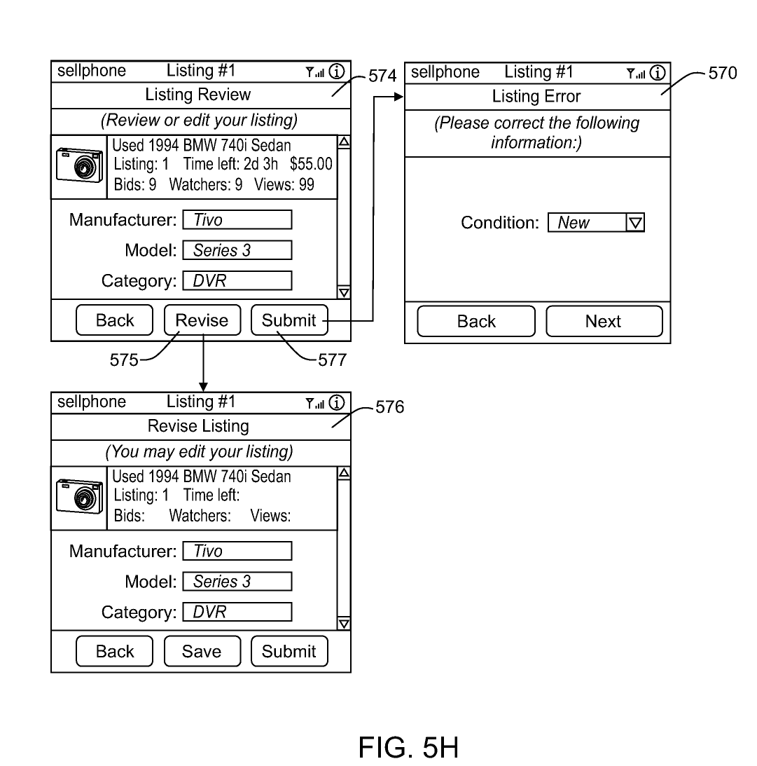

An exemplary embodiment of the inventive system, employed on an advanced PDA/Cellular Phone such as a Palm® Tree™ Smart Phone with touch screen capability activated by contact of the user's finger or a stylus (referred to herein as “touching”), is shown with interactive screen shots for the PDA using processes described in FIGS. 5A through 5I, 6A through 6C and 7A through 7D. Referring to FIGS. 5A through 5I, the system display for the exemplary embodiment provides a welcome screen 502 when initialized. The initial screen includes multiple interactive buttons for selection of available functions such as new listing 503a, my account 503b, messages 503c, and settings 503d. A quit button 504 allows for exiting the program. Touching the new listing button brings up a photo entry screen 505 as shown in FIG. 5B. The screen provides buttons for function selections: a yes button 506 to engage the camera function or a no button 507 to advance to the next screen. A back button 508 is provided to return to the listing text element screens. If the yes button is touched, a photo selection screen 509 is presented providing the option to select a photo from memory with a browse button 510 or capture a new image with a shoot button 511. Touching browse brings up an image memory screen 512 displaying icons for photos and video available in memory on the PDA. A view button 513 allows a selected image/video to be viewed and a next button 514 allows the image to be entered as the selected photo for the listing.

Alternatively, if a new photograph is desired, touching the shoot button on the photo entry screen initializes the internal camera function of the PDA allowing normal image capture represented by icon 515. The image is then displayed in a photo confirmation screen 516 which prompts the user to accept the image with a yes button 517 or reject it with a no button 518. A no selection deletes the image. A yes selection stores the image and brings up an additional photo selection screen 519 which provides a yes button 520 and a no button 521. A yes selection returns to the image capture sequence. A selection of the no button enters the image or images taken into the listing and advances to a record video option screen 522 providing a selection sequence for video comparable to the photo selection having video selection screen 523 with access to the image memory through screen 512 or activation of the internal video capture capability of the PDA 524, video confirmation 525 is provided having similar functionality to the image screen 516 as previously described. Upon completion of the image entry routines, a listing title screen 526 is presented which prompts the user to enter a title for the listing in a text entry block 527. For the embodiment shown an example block 528 provides additional assistance to the user. Next 529 and back 530 buttons are provided to advance after entry of the title or return to the welcome screen.

Touching next after entering the title brings up a subtitle screen 531 for optional entry of a subtitle in text entry block 532. As with the title entry screen, an example prompt 533 is provided which also can include information on system requirements or interaction such as the requirement for additional fees to enter a subtitle in the sales provider's system. Next 529 and back 530 buttons are again displayed for exiting the screen. Touching next brings up a condition screen 534 for entry of information on condition of the sale item. For the embodiment shown, a drop down box 535 with predetermined condition definitions is provided as well as a text entry box 536 for detail description. The condition entry screen is exemplary of the data input screens available for the system which are tailored for interface between the service provider system and the PDA. As will be described below, the PDA can initially prompt for a service provider definition prior to commencing the new listing process which will select and sequence the input screens based on the data available or required for listings on that service provider's system.

ting, touching next brings up a sales type option screen 583. Consistent with most current sales service provider systems, a fixed price button 537 and an auction button 538 are provided. For the embodiment shown, a check box 539 is associated with each sale type for selection. Touching the auction button launches an auction screen 540 providing text entry blocks for starting bid 541, reserve 542 and retail value 543 with a drop down box 544 with preselected auction periods. Similarly, pressing the fixed price button launches a fixed price sale screen 545 with text entry blocks for “Buy It Now” pricing 546 and retail value 547 and a drop down box 548 with preselected sales periods.

Completing or skipping the sales type screens, a shipment selection screen 549 is launched providing drop down boxes for shipment carrier 550 and pricing 551, which for the embodiment shown allows either fixed rate or calculated. A fixed rate selection allows entry of a shipping rate in text box 552. A packaging type drop down selection 553 is also provided. A selection of “calculated” in the drop box as shown in shipment selection screen 549 brings up a screen 554 for entry of shipping data such as weight and dimensions in text entry boxes 555.

Continuing with FIG. 5F, additional item information screens such as manufacturer screen 556 and model number screen 557 provide text boxes for entry of data. For commonly offered manufacturers, the system will provide preloaded data which is presented in additional screens such as the category selection screen 558 for selection by the user to supplement entered data. A final listing description is displayed in a review screen 559 with scroll bars 560 allowing the user to verify data as entered and as will be presented to the sales system provider for uploading and presentation to their customers. For the embodiment shown, elements of the description that have been entered are shown in highlighted text 561 and touching the highlighted text will return the user to the entry screen for that element to allow revision or correction.

Data for the created listing is now complete in the PDA based system. A listing location screen 562 is then presented to the user identifying the various sales service providers with which the PDA has been registered as previously described. Selection boxes 563 allow one or more listing services to be employed. A sell button 564 is provided for connection with the selected sales service provider. Upon connection and transmission of the listing to the provider, a payment confirmation screen 565 is presented with option buttons. In the exemplary embodiment shown, the confirmation screen provides cost information for the listing. An accept button 566 allows the user to accept the costs and enter the listing on the service. If the listing is error free, a submission success screen 567 is presented. On the exemplary screen, the user can then select a done button 568 to exit the system or a new listing button 569 for selection of an additional listing for entry from titles of saved entries.

If an error is identified in an attempted submission, a listing error identification screen 570 is presented identifying to the user that an error exists and requiring correction through logging on to the sales service provider's system via an internet terminal. This screen then gives the user option buttons for done or a new listing selection.

As an alternative to accepting the entry of the listing on the service, a save button 571 on the payment confirmation screen allows the user to store the listing data with the sales service provider for future access. If this option is selected, a data saved confirmation screen 572 is presented which again provides done or new listing selection buttons.

At the listing location screen 562 a review button 573 is also provided to allow the user additional options prior to entry of the listing with a sales service provider. If a single service provider has been selected, selection of the review button prompts a listing review screen 574 allowing the user to review all elements of the listing. A revise button 575 allows the user to access the various data entry screens through a revise listing screen 576. A submit button 577 is selectable to create an automated review of the listing. If successful, the listing locations screen is presented again. If an error is detected, a listing error screen 570 is presented which identifies the error and allows correction. Upon correction, the listing location screen is again presented to allow a sell button selection. A save button 571 is provided to allow the listing to be saved in the PDA memory.

At the listing location screen 562, if multiple sales service providers are selected as represented in the listing location screen as shown, options for the service providers are presented responsive to a next button selection in listing upgrade screens 580 providing various entry options. For the embodiment shown, warning screens 581 are presented if selection of entry options results in additional cost. Selection of the desired options and selection of a next button and/or acknowledgement of the warning screens by selection the next button results in submission of the listing to the service provider with presentation of the payment confirmation screen.

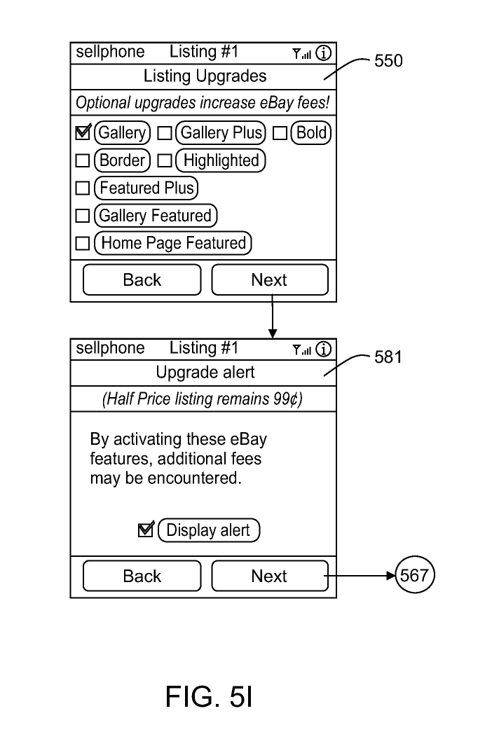

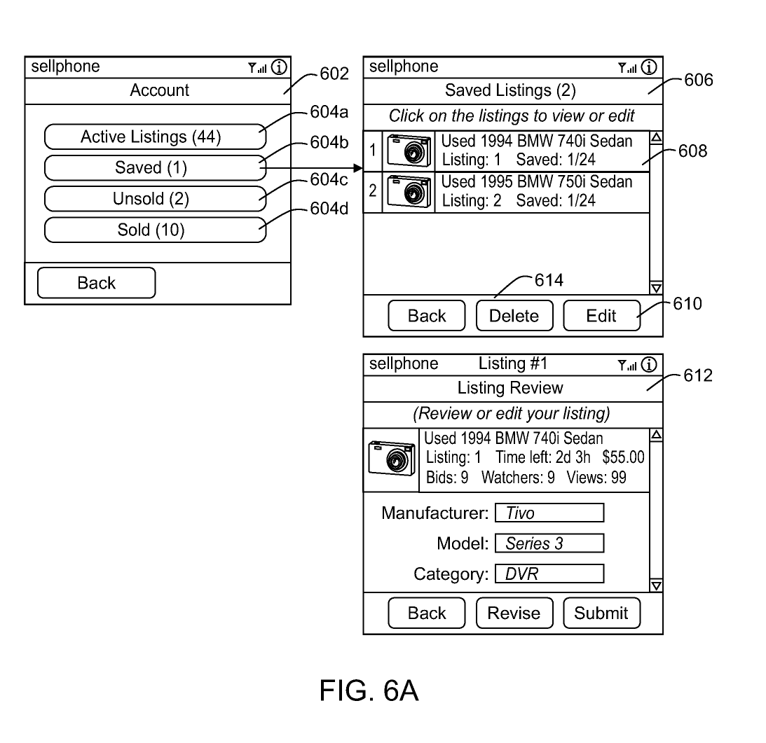

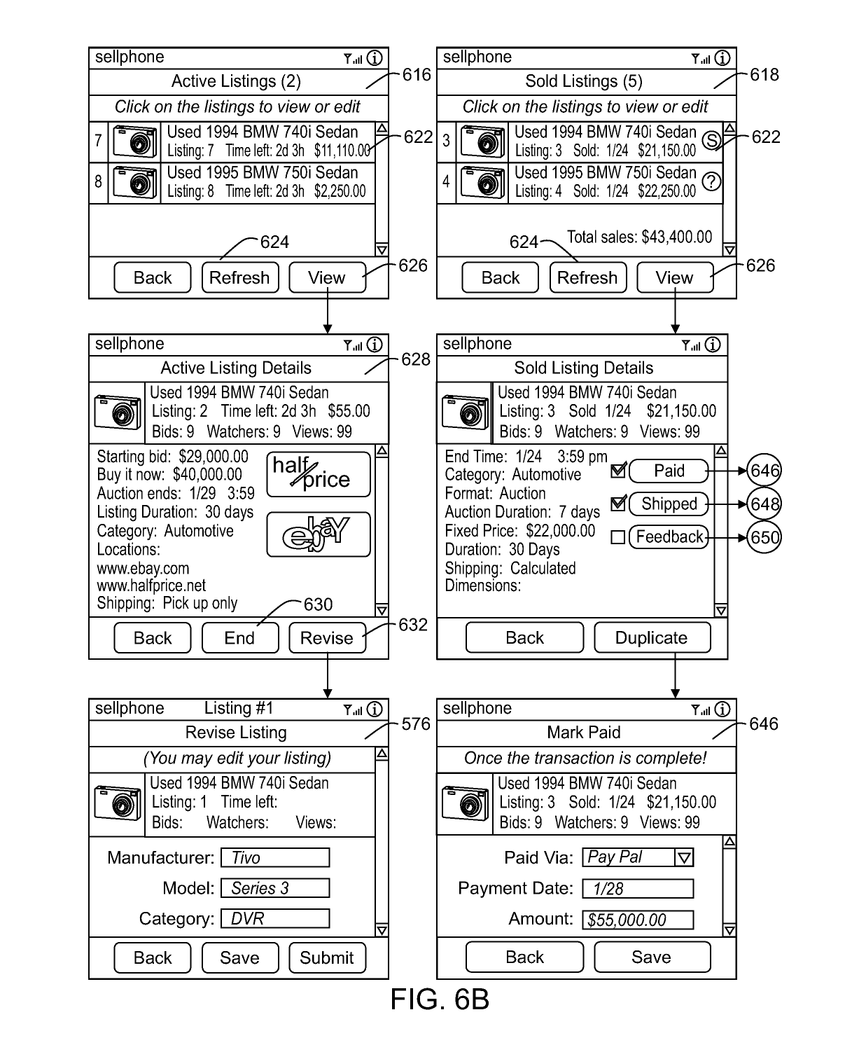

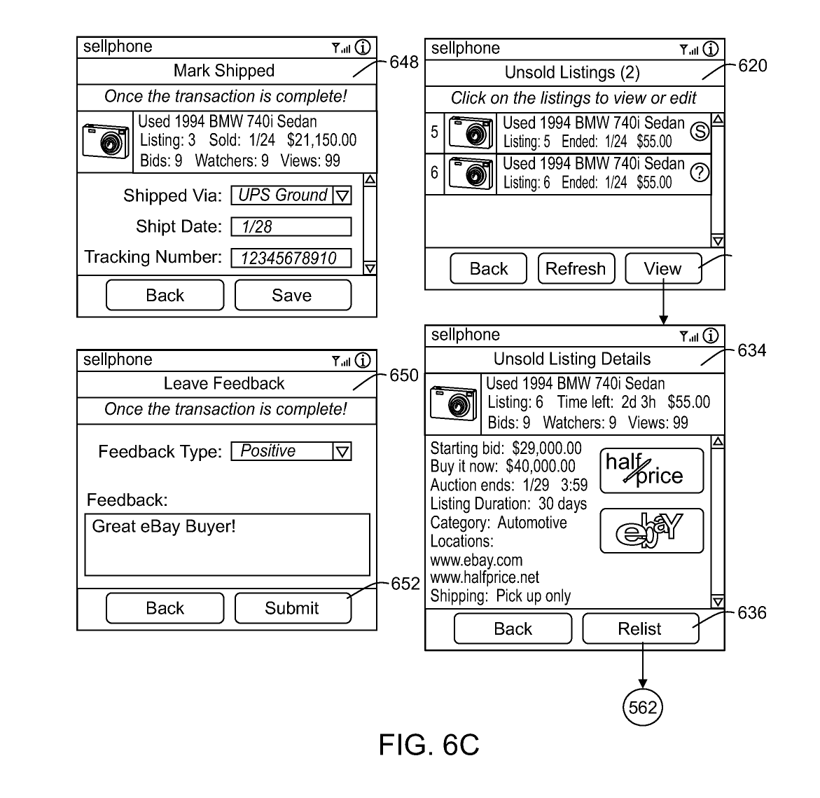

As previously identified with respect to the welcome screen 502 presented to the user upon initializing the system on the PDA, additional capability is provided as shown in FIGS. 6A through 6C for account maintenance upon touching of the my account button 504b. An account screen 602 is presented with option buttons for review of saved listings 604a, active listings 604b, unsold listing 604c and sold listing 604d.

Selection of the saved listings button launches a saved listing screen 606 which provides identifiers 608 for each listing save in the PDA memory. An “edit” button 610 is provided for selection by the user to produce a listing review screen 612 of a selected listing with the features previously described to revise or submit the listing. Alternatively, a delete button 614 is provided to allow deletion of a selected entry.

The active listing, unsold, and sold selection buttons for the account screen provide information on listings previously submitted and prompt information and response screens based on interactions typically required with the sales service providers. Touching the respective buttons results in presentation of an active listing screen 616, a sold listings screen 618 or an unsold listings screen 620 respectively. Each of these screens provides identifiers 622 for each listing in that category, a refresh button 624 for connection to the service provider to update the status of the listings and a view button 626 to view the listing for a selected identifier.

For the active listings, responsive to the view button for a selected identifier, a details screen 628 is presented with all elements of the listing and the transaction status with the sales service provider's system. An end button 630 is provided to terminate the listing. A revise button 632 is provided to launch a revise listing screen 576 with functionality as previously described.

For unsold listings, responsive to the view button for a selected identifier, an unsold listing details screen 634 is presented showing the details of the listing and providing a relist button 636 which when touched transitions that listing to the listing locations screen 562 for reprocessing.

Finally, for sold listings, responsive to the view button for a selected identifier, a sold listing details screen 638 is launched which details the listing and provides buttons for designating paid 640, shipped 642 and feedback 644. Each of these buttons launches one of three respective screens; mark paid 646, mark shipped 648, and leave feedback 650 which allow entry of details regarding that function as text and/or drop down boxes. The leave feedback screen, in turn, has a submit button 652 allowing text feed back entered on the screen to be submitted to the buyer through the sales service provider system.

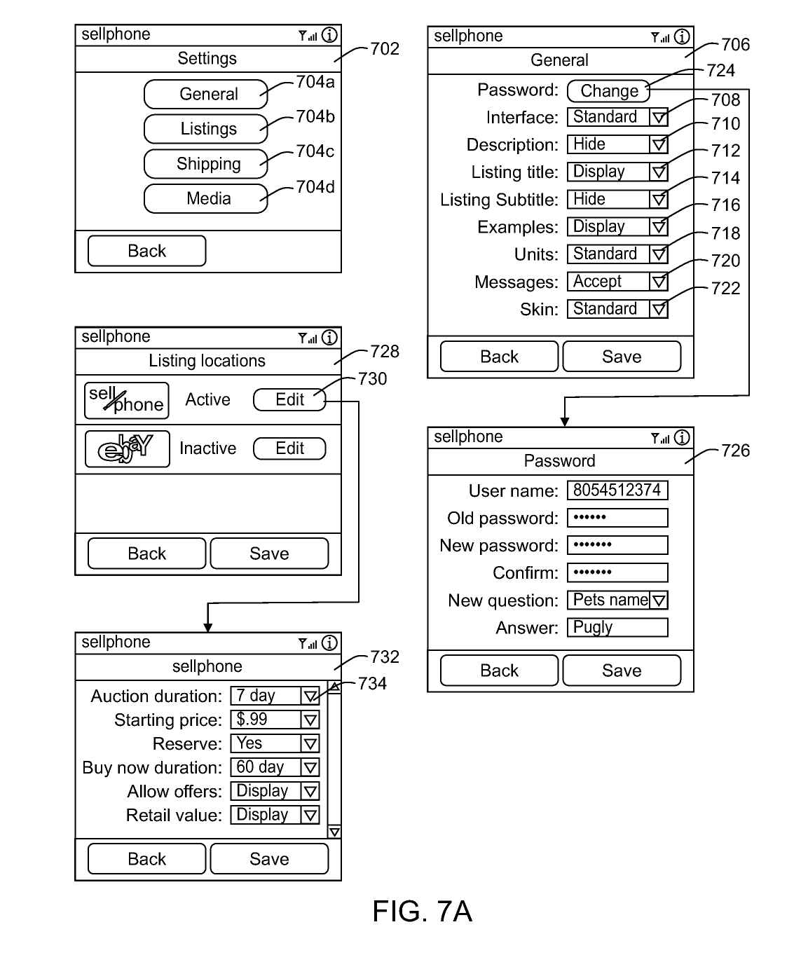

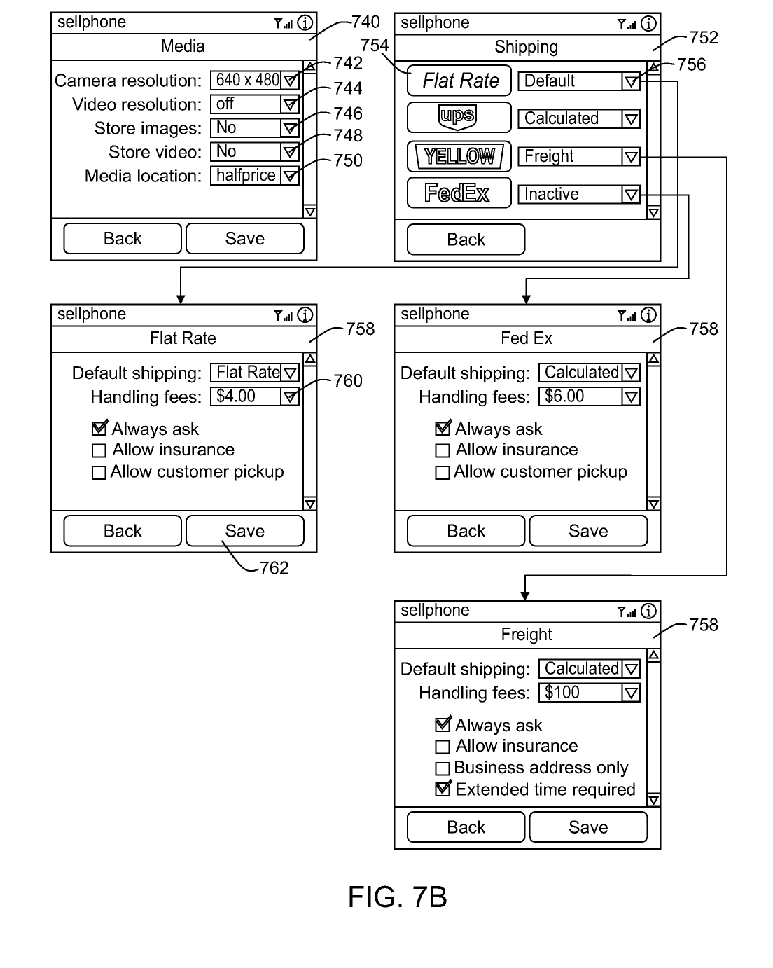

Returning to FIG. 5A, selection of the settings button 504d on the welcome screen launches a settings screen 702, as shown in FIGS. 7A and 7B, which provides for entry and selection of preferences for system elements. A “general” button 704a launches a general preferences screen 706 which identities and provides for modification of system preferences such as, for the exemplary embodiment shown, interface with the sales service provider's system using a drop down box 708 for preselected interface options. An ability to hide or show the description of listings is provided with a drop down box 710, listing title with drop down box 712, listing subtitle with dropdown box 714 and examples with drop down box 716. A selection of units of measure for the shipping and other system functions is provided in drop down box 718. Enabling or disabling message communication with the PDA by the sales service providers is established using drop down box 720. A “skin” or screen appearance is provided via drop down box 722. A button to change password 724 launches a password screen 726 which allows entry of password information and verification data.

A listings button 704b on the settings screen launches a listing locations screen 728 which identifies the sales service providers with which the PDA system is registered. The listing locations screen allows selection of and identifies the status of each provider as active or inactive and provides edit buttons 730 for modification of general data inputs specifically associated with each provider. As exemplary, provider screen 732 incorporates drop down boxes 734 for selection of default values for such values as auction duration, auto re-list, starting bid, reserve, make offer, retail value, subtitles, picture options, picture show, Gallery options and Text options. Similarly, alternate provider screens provide similar selection capability for each alternative provider.

A media button 704d on the settings screen launches a media options screen 740 which allows selection of properties for media to be used in association with the listing including camera resolution with a drop down box 742 and video resolution with drop down box 744 to allow the user to maximize storage. An option to store or not store images or video generated during development of listings is provided in drop down boxes 746 and 748. If media is not permanently stored on the PDA, transfer of the listing data generated in the listing process previously described will result in deletion of the associated media files for that listing in the PDA memory. For a sales provider with which media storage is provided with listings, a drop down box 750 for identification of that provider is available.

Finally on the settings screen a shipping button 704c is provided to launch a shipping screen 752. The shipping screen incorporates selectable identifiers 754 for multiple shipping entities with drop down boxes 756 for selection of shipping types assigned. Selection of the identifier for any shipping entity launches an entity screen 758 which provides detail information selectable by dropdown boxes 760 for shipping alternatives to be presented as a portion of prepared listing.

In each of the preferences screens a save button 762 is provided to save changes to the preferences entered on the screen.

Networked Environment

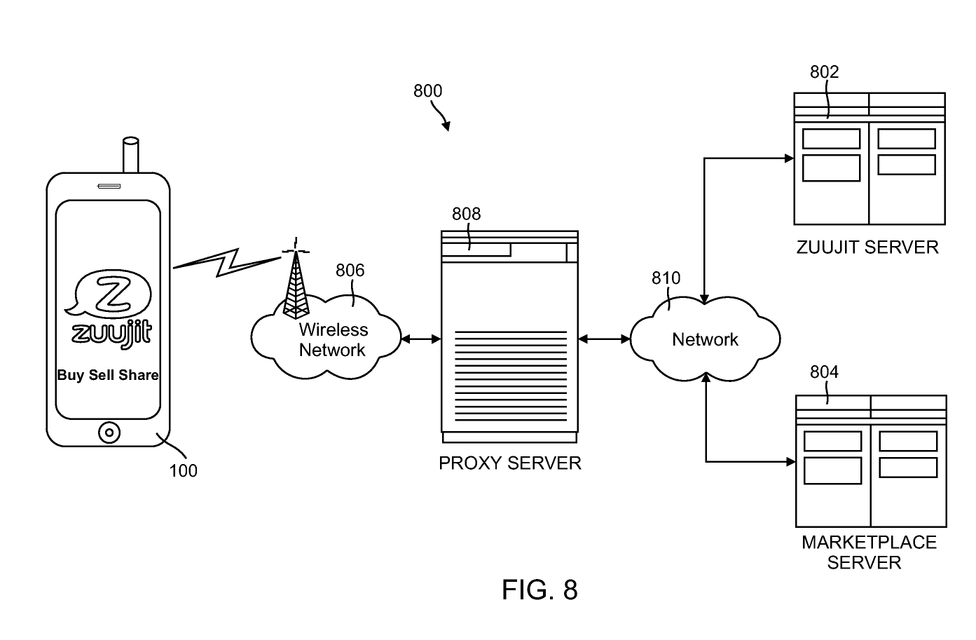

With reference now to the present application, a user interface for a wireless device 100 will hereinafter be described. Before describing aspects of the user interface, however, an exemplary networked environment 800 in which the wireless device 100 can be used will be described as shown in FIG. 8.

Wireless device 100 can be a mobile (e.g., cellular) telephone, PDA, or two-way pager. In essence, the wireless device 100 is configured to retrieve remotely stored hypermedia information, such as WML card decks, HTML documents, compact HTML (cHTML) documents, extensible markup language (XML) documents, or HDML documents, from one or more network servers, shown as Zuujit Server 802 and Marketplace Server 804. Furthermore, wireless device 100 is capable of downloading programs and executing those programs. In preferred embodiments, the user interface described herein is downloaded onto the wireless device 100 so that the user interface can be used for a single application, multiple applications, or be the entire interface between the network servers. Alternatively, the user interface described herein can be part of the documents transferred from the network servers.

Wireless device 100 can execute a browser, which is software that allows the user of the wireless device 100 to access and navigate content on the Internet or other network, including browsing the World Wide Web or any other “web” of hypermedia content. The browser can be stored in memory within the wireless device 100. The browser generates a GUI via the display to enable the user of the wireless device 100 to access and retrieve hypermedia information from network servers 802 and 804. Various features of the GUI which make the browser more user-friendly are described below.

While wireless devices 100 are preferred, one skilled in the relevant art will appreciate that the present application is not limited to such. For example, a desktop or laptop can be used for displaying the user interface presented herein.

The network servers 802 and 804 can be, for example, conventional personal computers (PCs), server-class computers, or computer workstations. The servers 802 and 804 can run administrative software the controls access to the network and its resources, and furthermore, provide resources to computers functioning as work stations on the network. A computer or program on the servers 802 and 804 can respond to commands from a client. For example, the server 802 and 804 can contain an archive of data or program files and when a client submits a request for a file, the servers 802 and 804 transfer a copy of the file to the client.

Zuujit Server 802, as will be shown in the following discussion, provides a wireless device 100 with an application for buying and selling items. Marketplace Server 804, along with the Zuujit Server 802, allows a user to post items on an online auction and/or shopping website, the website giving the opportunity for users to buy and sell a variety of goods and services. In one embodiment, the Marketplace Server 804 is an eBay server that interfaces with the wireless device 100. Alternatively, the Marketplace Server 804 can include craigslist, stubhub, etc. Generally, Marketplace Server 804 is any type of server that provides a website where users can post information about an item or service so that the item or service can be purchased by others.

The communication path between wireless device 100 and network servers 802 and 804 can include a wireless communication network 806, a proxy server 808, and a network 810. The wireless network 806 can be a wireless telecommunications network such as a cellular digital packet data (CDPD) network, a global system for mobile (GSM) network, a code division multiple access (CDMA) network, or a time division multiple access (TDMA) network. The communications protocols used by wireless network 806 can include, for example, WAP and/or HDTP. The network 810 is a land-based network that can be or include the Internet, an intranet, or a data network of any private network, such as a local area network (LAN). The communication protocol supporting network 810 can be, for example, transmission control protocol/Internet protocol (TCP/IP), HTTP, or secure HTTP (sHTTP).

Proxy server 808 acts as a bridge between wireless network 806 and network 810. Proxy server 808 can be, for example, a conventional server-class computer or PC. Although shown as a physically separate device, proxy server 808 can be implemented in a network server (e.g. network servers 802 or 804) with hardware and software well known in the art providing the connection between wireless network 806 and network 810. Proxy server 808 can also provide gateway functions, such as translation/conversion between the language(s) and protocol(s) used on the wireless network 806 and those used on network 810.

One skilled in the relevant art will appreciate that this is an exemplary environment 800 and should not be construed as limiting to the scope of the present application. For example, multiple proxy servers 808 can be included along with numerous wireless devices 100.

Wireless Device (External)

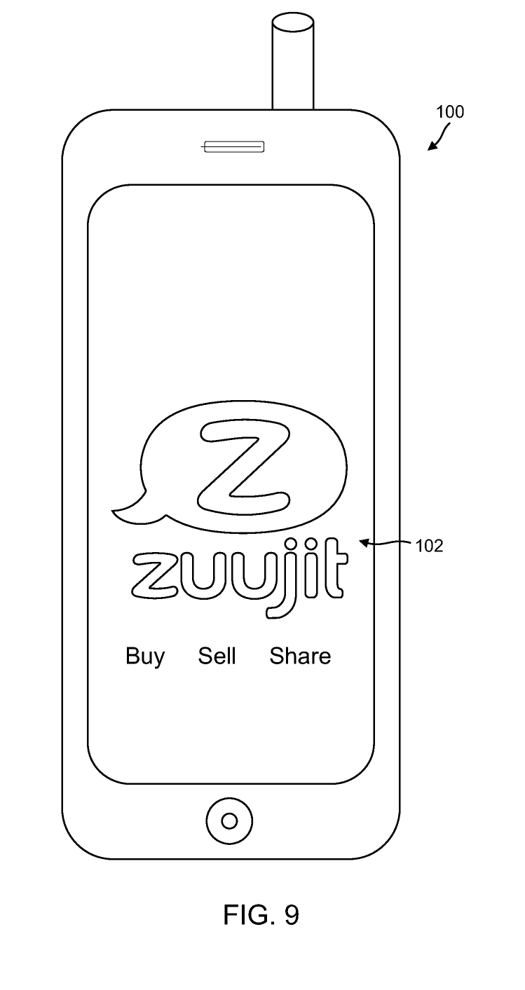

FIG. 9 is a schematic view of the illustrative wireless device 100 that can be used to access a network, according to one embodiment. As shown, wireless device 100 can include a display 902. Preferably, the display 902 is a touch screen allowing the user to press buttons and tabs or scroll sliders within the display 902 to perform a variety of tasks.

Wireless Device (Internal)

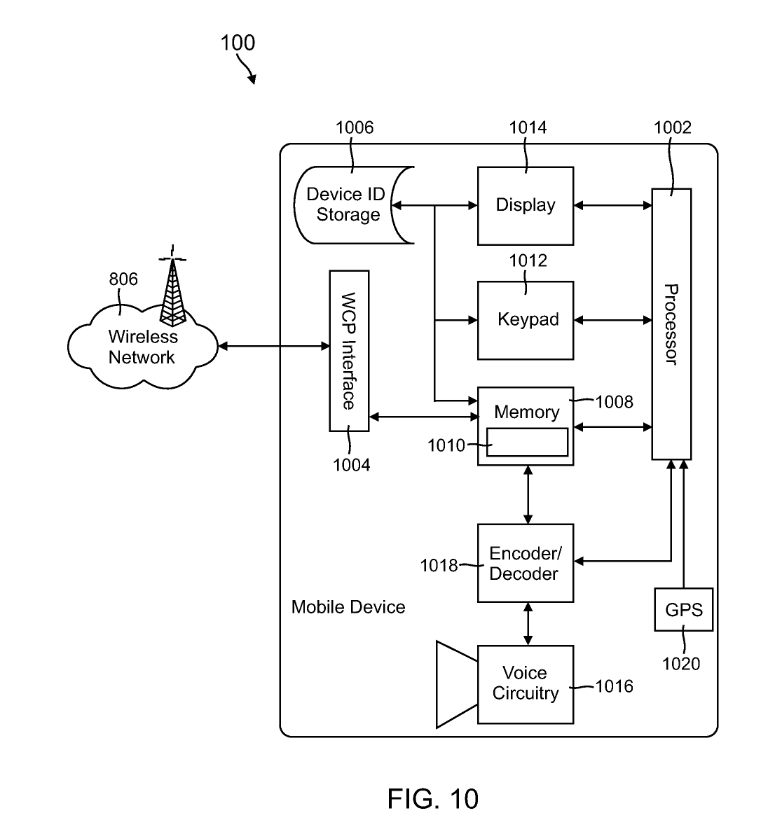

FIG. 10 is an illustrative hardware diagram of the exemplary wireless device 100 in accordance with one aspect of the present application. In this embodiment, the wireless device 100 includes a processor 1002, which may be, or may include, any of: a general-purpose or special-purpose programmable microprocessor, digital signal processor (DSP), microcontroller, application specific integrated circuit (ASIC), programmable logic array (PLA), field programmable gate array (FPGA), etc., or any combination thereof. Wireless device 100 includes a Wireless Control Protocol (WCP) interface 1004 that couples to a carrier network via wireless network 806 to receive incoming and outgoing signals. Device identifier (ID) storage 1006 stores and supplies to WCP interface 1004 a device ID which identifies wireless device 100 to outside entities (e.g. proxy server 808). The device ID is a specific code that is associated with wireless device 100 and directly corresponds to the device ID in the user account typically provided in an associated proxy server device, such as proxy server 808.

In addition, wireless device 100 includes memory 1008 that stores data and/or software for performing many of the processing tasks performed by wireless device 100, including an application 1010, when executed by processor 1002. These tasks include: establishing a communication session with a proxy server 808 device via wireless network 806; receiving user inputs from keypad 1012; requesting and receiving data from the wireless network 806; and displaying information on the display 1014. Hence, memory 1008 may represent one or more physical memory devices, which may include any type of random access memory (RAM), read-only memory (ROM) (which may be programmable), flash memory, non-volatile mass storage device, or a combination of such memory devices. Memory 1008 is also coupled to WCP interface 1004 for the establishment of a communication session and the requesting and receiving of data.

The wireless device 100 also includes voice circuitry 1016 for inputting and outputting sound during a telephonic communication between the user of wireless device 100 and a remote party. Voice circuitry 1016 includes circuitry to process telephony signals and may include, for example, sound transducers, analog-to-digital (A/D) and digital-to-analog (D/A) converters, filters, etc., such as are well-known in the art. An encoder/decoder 1018 is coupled between the processor 1002 and the voice circuitry 1016 for encoding and decoding audio signals.

The wireless device 100 also may include a conventional global positioning system (GPS) location device 1020 or another, similar type location device, which precisely determines the geographic location (latitude and longitude) of the wireless device 100. The location of the wireless device 100 may be used to provide an indication of the location to the user and/or to provide location-dependent information or services for the user. Alternatively, the location of the wireless device 100 may be determined by a device or system external to the wireless device 100, such as a remote location server on the wireless network 806.

Conversational Interface

What follows is a description of certain features of the conversational interface generated by the application 1010 of the wireless device 100, which may be implemented in a given embodiment, to make the wireless device 100 more user-friendly. It will be readily apparent to those skilled in the art how to implement these features provided by the application in program code, from the following description of the user-perceivable characteristics of these features. The application 1010 incorporating these features may be implemented in any programming language that is currently used for wireless devices 100. Preferably, the conversation is driven by an XML document and can be identical to that of an SMS application.

As an alternative to the application 1010 generating the following GUI features, these features can instead be provided by a remote device (e.g. proxy server 808 or servers 802 or 804), such that the wireless device 100 only receives and displays these features to the user.

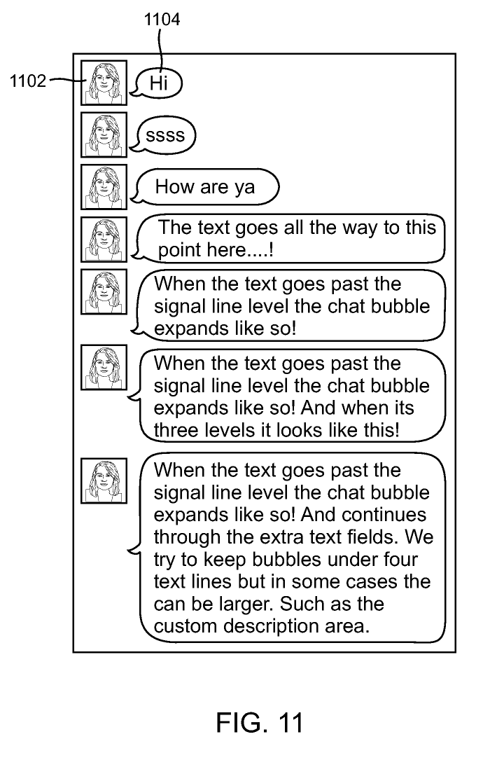

FIG. 11 provides a standard conversation window displayed on a wireless device 100 in accordance with one aspect of the present application. In one embodiment, the display 902 along with the application 1010 provides an interactive way for users to buy or sell items using their wireless device 100. Alternatively, the interactive application 1010 can be used for any other type of data gathering objectives.

Chat Bubbles

As shown in FIG. 11, a two way dialogue can occur between a digitized character 1102 and a user. Chat bubbles 1104 allow the digitized character 1102 to provide questions to the user and a following set of chat bubbles allows the user to answer those questions by the digitized character 1102. Typically, the questions will be left-justified and in green chat bubbles 1104. On the other hand, a user's answer will generally appear in right-justified with white chat bubbles 1104.

The flow of the conversation between the digitized character 1102 and the user can be read from top to bottom. Each new chat bubble 1104 can appear at the bottom of the display 902 resulting in older chat bubbles 1104 being pushed up and eventually out of the display 902.

In preferred embodiments, the chat bubbles 1104 can fade after a predetermined period of time. For example, a chat bubble 1104 can be displayed for about two hundred and fifty (250) milliseconds. The voice circuitry 1016 can play sound effects with the appearance and disappearance of each chat bubble 1104 on the display 902. Chat bubbles 1104 can expand in both width and height to accommodate text from the digitized character 1012 or the user.

As shown in FIG. 2, the space on display 902 is very limited generally making it difficult for providing decipherable information. Nonetheless, through the chat bubbles 1104 and the below-mentioned exemplary dimensional aspects, the application 1010 can generally provide clear graphics to display useable information. One skilled in the relevant art, however, will appreciate that there are a number of dimensions that can be used with the presented conversational interface.

Typically, there should be a minimum five (5) pixel margin on all four sides of the text entered into the chat bubbles 1104. The maximum width of a chat bubble 1104 is the display 902 width minus the margins. For the iPhone, the maximum width of a chat bubble 1104 is two hundred and sixty two (262) pixels. The margins generally run around two (2) by seven (7) pixels.

The thumbnails, or profiles of the digital character 1102 or user, are about thirty-five (35) pixels. Other spacing can be about nine (9) pixels. For example, the space between the thumbnails and the chat bubble 1104 edges.

Generally, if a word does not fit within the two hundred and fifty two (252) pixels (two hundred and sixty two (262) minus two (2) by five (5) pixels for text margins) the text can wrap to the next line. As shown in FIG. 11, the minimum width for chat bubbles 1104 can be thirty-six (36) pixels. The minimum vertical spacing between chat bubbles 1104 or thumbnail images, whichever is smallest, can be seven (7) pixels.

The point of the chat bubble 1104 arrow, which points at the thumbnail, can be horizontally three (3) pixels from the thumbnail's edge and vertically twenty-six (26) pixels below the top edge of the thumbnail.

As will be shown, the sequence illustrated by the chat bubbles 1104 on the display 902 simplifies data gathering in the context of the application 1010, i.e., while the application 1010 is active and displayed to the user. As will be described, to enter data, the user simply uses the chat bubbles 1104 along with input controls by pressing the touch screen, the screen having scroll bars, text entry, numeric entry, etc.

Thumbnails

Continuing with FIG. 11, both the digitized character 1102 and the user can have thumbnail images. In one embodiment, the thumbnails can measure thirty five (35) by thirty five (35) pixels. Generally, the digitized character 1102 will have a preset image. On the other hand, a dummy image for the user can be used if the user has not created a profile image for their thumbnail.

Editing of Values

By incorporating chat bubbles 1104 into the application 1010, a user can modify a past response by simply selecting a chat bubble 1104. As an example, initially, a user chose “New” as the condition and then proceeded creating the listing. After entering the weight, the user realizes that the condition is in fact “Like New”. The user would then scroll up in the chat to the condition question or chat bubble 1104 and tap on the display 902 to select one of them. The corresponding input control would appear (condition in this case), and the user could change the value to “Like New”. Upon pressing “ok”, the conversation would scroll back to the bottom, and there would be a new, white chat bubble from the user saying “Actually, the condition is Like New” or something similar. The digital character 1102 would then respond with a statement such as “Thanks for letting me know.” At this point, the conversation should resume where it left off, with the digital character 1102 reminding the user what to do next.

Input Controls

Often the conversation between the digitized character 1102 and the user will require input based on the dialogue presented in the chat bubbles 1104. Input controls that allow the user to enter in information and provide answers to the questions provided by the digitized character 1102 can include single selection controls, multi selection controls, numeric controls, and text entry controls. Each will be described in the discussion below.

Multiple Users

While the previous discussion related to a two way dialogue between the digitized character 1102 and a user, one skilled in the relevant art will appreciate that multiple users can be involved on the single user interface. In one embodiment, a third party can also ask for data related to the user. This third-party could include their own thumbnail image and be capable of sending chat bubbles 1104 as well. In other embodiments, the wireless device 100 can communicate with other users who also have a wireless device 100 in a chat room. This chat room can be related to specific topics and the users can communicate with each other using their chat bubbles 1104.

Transitions

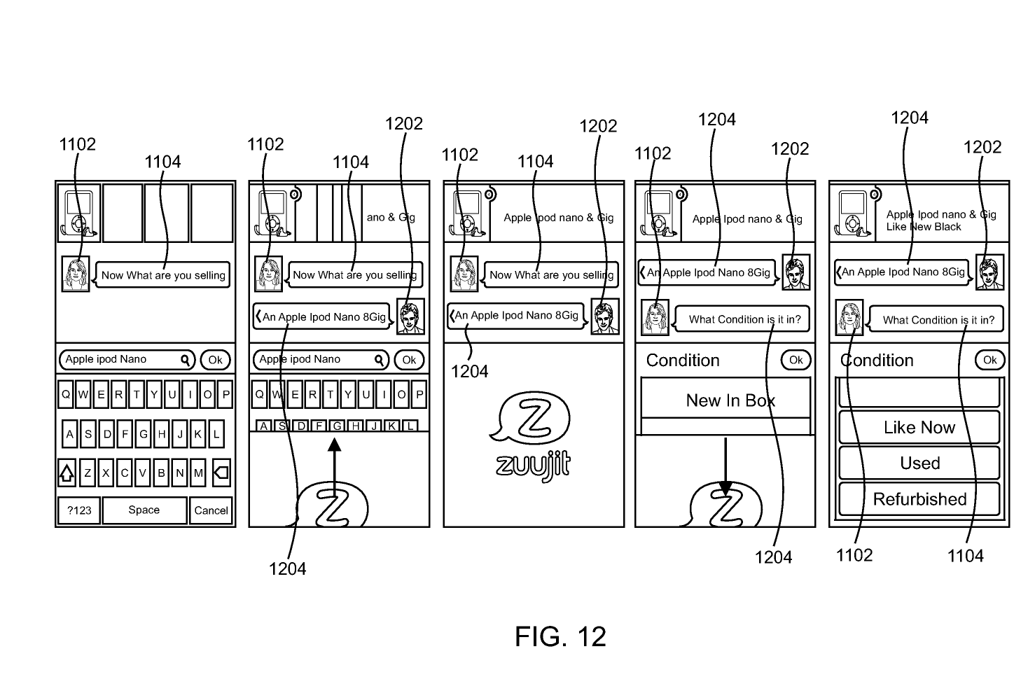

With reference now to FIG. 12, transitions between input controls within the standard conversation window displayed on the wireless device 100 are presented. To facilitate a friendlier user interface, transitions between the chat bubbles 1104 are provided. More often than not, input controls can be visible throughout the conversation.

In one embodiment, as soon as the digital character 1102 asks a question through a white chat bubble 1104, the appropriate input control appears on the display 902. Through the input control the user can make a selection. A small delay can take place (mimicking the “typing time” of the digital character 1102). This delay could be due to a specified pause, or to hide the latency of an API call.

As soon as “ok” or “skip” is tapped, a “cover” will quickly slide up from the bottom of the screen (duration about two hundred and fifty (250) ms). As this is happening, the user's answer can fade into view in a white chat bubble 1204.

The cover can remain visible until the delay has passed, at which point the next question will appear in a green chat bubble. At the same time, it will slide back down, revealing the appropriate input control for the question. It is possible that during long delays (usually for server latency masking), the digital character 1102 might provide comments to the user through the user profile 1202, such as “Just a second while I figure out what the problem is . . . ”. These comments should appear as part of the normal conversation while the “cover” is visible.

Hiding Input Controls

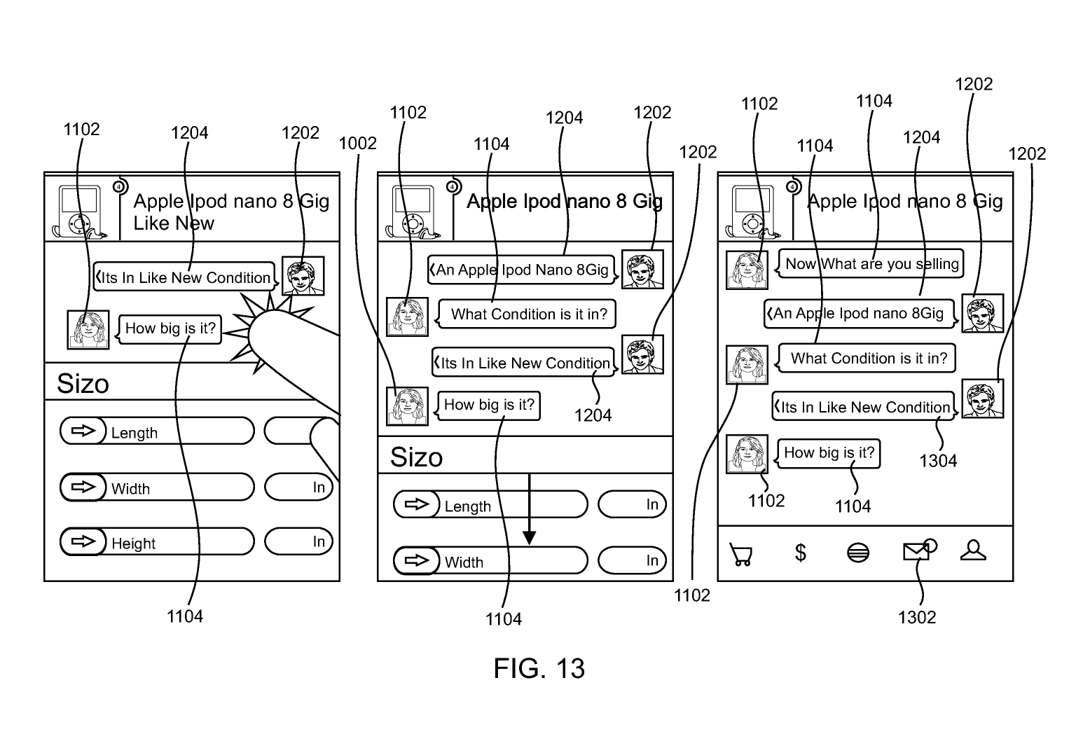

Often the user can choose to look back at the conversation between the digital character 1102 and themselves. FIG. 13 shows a typical sequence of routines used for hiding input controls on the standard conversation window displayed on the wireless device 100, according to one aspect of the present application.

The display 902 along with the application 1010 allows the user to hide the input control at any time by tapping anywhere on the background of the conversation pane. This causes the input control to slide downward to an off screen position. In doing this, the chat bubbles 1104 and 1204 remain in place (i.e. they will not move down with the top edge of the input control), leaving a blank area where the input control was.

At the bottom of the screen can be a tab bar 1302, which can be present at all times, though hidden by the input controls. Tapping on the background again can cause the input control to reappear from the bottom of the screen. In the event that the conversation has been scrolled down, the reappearance of the input control can cause the bottom most chat bubble 1104 and 1204 to be visible above the top edge of the input control.

Single Selection Controls

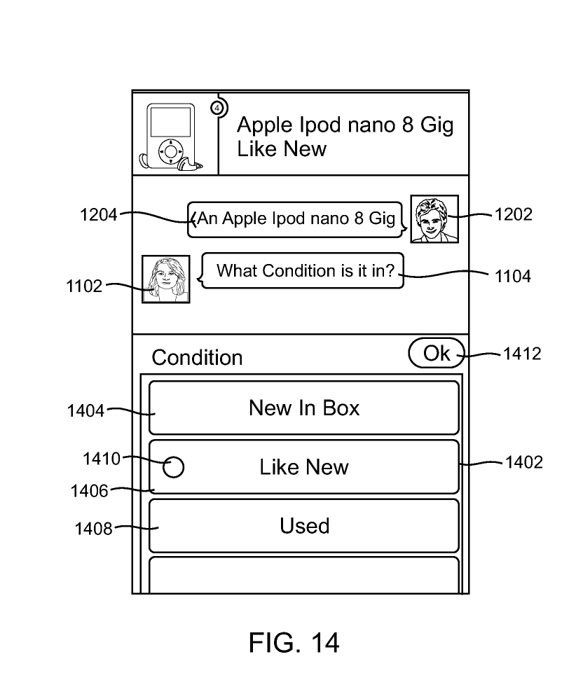

In the previous discussion, input controls were described that allow a user through their user profile 1202 to enter in input so the application 1010 can gather data for use. Generally, the input controls allow a user to provide a single selection as shown on the wireless device 100 depicted in FIG. 14. The single select input control 1402 can provide a list of values from which the user through their user profile 1202 may choose indicated by the buttons 1404, 1406 and 1408. For example, if the user is choosing the condition of an item, the single selection controls 1402 may include “New In Box” 1404, “Like New” 1406, “Used”, and “Refurbished” 1408. The user may choose one and only one of these values before continuing. In one embodiment, a selection is indicated by the illumination of the blue dot 1410 on the left side of the “Like New” button 1406.

A button 1404, 1406 and 1408 can be deselected by tapping again on the button. The values will be presented to the user in a series of stacked buttons 1404, 1406 and 1408. For cases where there are only two or three available values (there will never be just one value), no scrolling can be allowed. In all other cases, the user can gesture up or down on the input control box to scroll the buttons 1404, 1406 and 1408 up or down.

In one embodiment, after a button 1404, 1406 and 1408 is pressed, the input control will be removed. Alternatively, the OK button 1412 needs to be selected and then the input control will be removed.

Required vs. Optional Selections

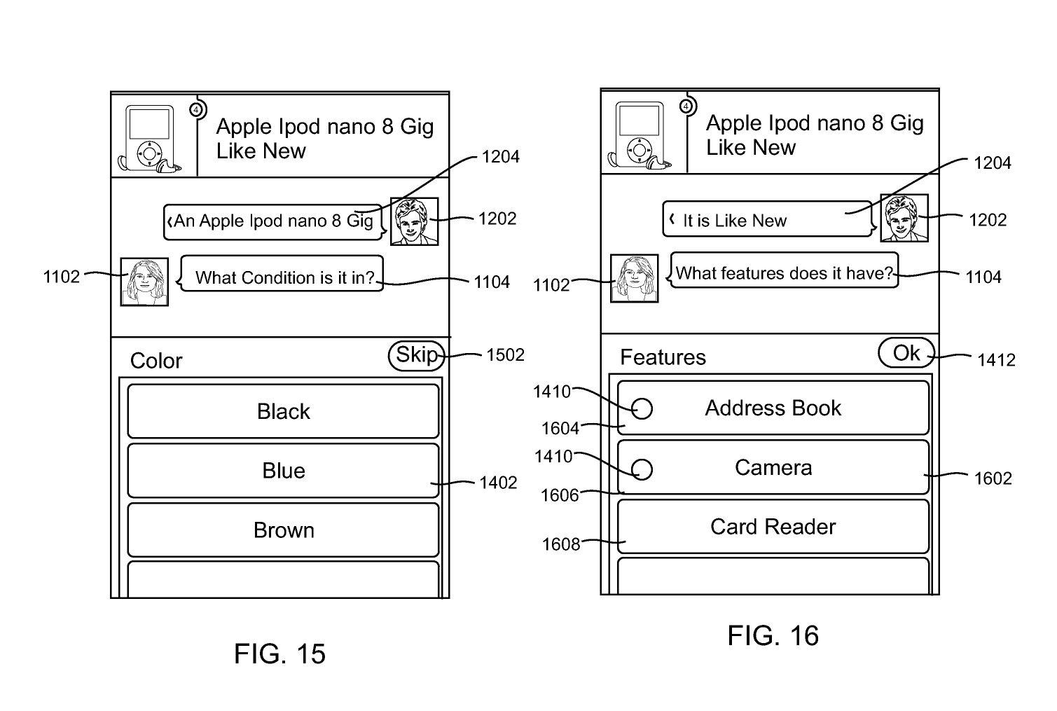

Typically, there are two types of selections that can be made within a single selection control 1402. In the case of a “required” single selection input control 1402, the user can choose a value before the “ok” button 1412 at the top right will become visible. For an “optional” single selection input control 1402, a “skip” button 1502 is visible until a value has been selected, at which point, the “skip” button 1502 becomes an “ok” button 1412 as depicted in FIG. 15.

While the required versus optional selections are shown to take place on the single selection controls 1402, one skilled in the relevant art will appreciate that these type of selections can be applied to other controls described herein.

Scrolling Animation

In preferred embodiments, the buttons on the input controls can scroll up and down. In essence, the scrolling features can be characterized by having the garage door effect. As the buttons are scrolling up, the top button will rotate and fall into the screen; the reverse behavior will can when scrolling down. Typically, no special effect can take place at the bottom—buttons can simply appear or disappear at the bottom screen edge as in traditional scrolling. In some embodiments, there can be a sound effect associated with the scrolling of the buttons.

Multi Selection Controls

With reference now to FIG. 16, illustrative multi selection input controls 1602 on the standard conversation window displayed on the wireless device 100 are presented. Generally, the multi selection input controls 1602 appear identical to the single select input control 1402, with the difference being that the user can, choose more than one value.

Typically, multi selection input controls 1602 allow a user to select from a set of available features. The corresponding blue dots 1410 can illuminate, indicating that the buttons 1604, 1606 and 1608 have been selected. A value can be deselected by tapping again on the buttons 1604, 1606 and 1608. Multi selection fields can exhibit the same scrolling behavior as the single selection controls 1402. In multi selection input controls 1602, there is no minimum or maximum number of values that can be selected. Normally, this means that there is no “required” or “optional” multi selection controls 1602. A user can choose none or all of the values offered. When the selections are made, the user can select the “ok” button 1412 to continue.

Numeric Input Controls

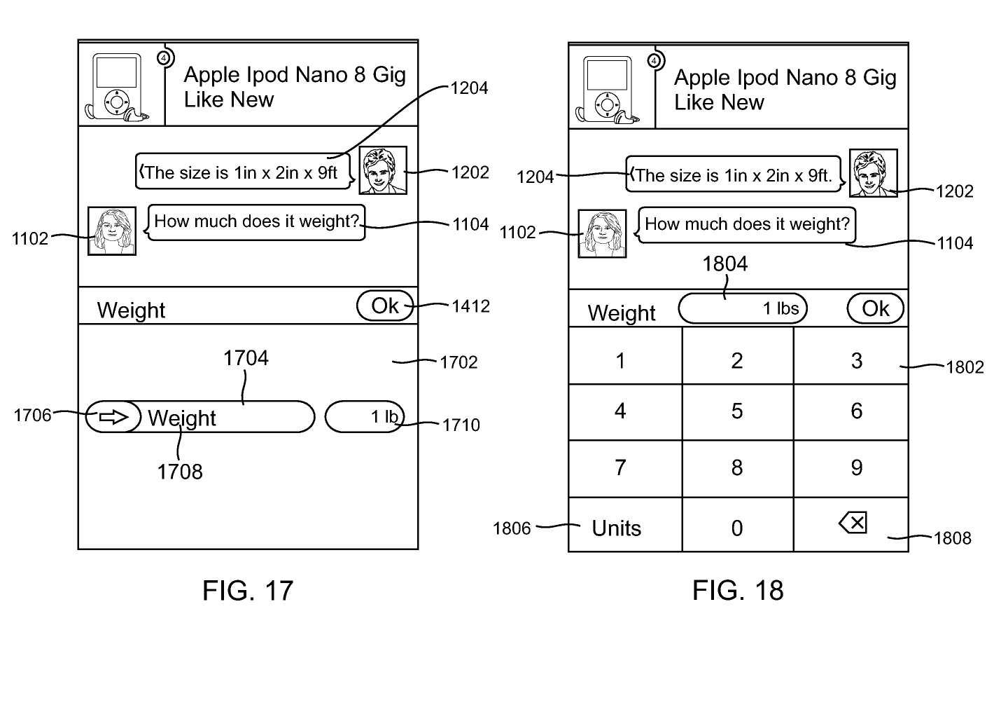

In addition to the single selection input controls 1402 and multi selection input controls 1602, numeric input controls 1702 can be provided as shown in FIG. 17. For question requiring a numeric answer by the digitized character 1102 through the chat bubbles 1104, the numeric input control 1702 can be provided to the user through display 902. In preferred embodiments, the control 1702 includes a slider bar 1704. The input label 1708, as shown as “Weight” in FIG. 17, appears to the immediate right of the slider control tab 1706, and can move with the tab 1706 as the user slides it left and right.

The default control is a slider bar 1704 with a specified minimum and maximum value. The user can drag the slider control tab 1706 left or right to change the value. The selected value and unit (e.g. inches, pounds, etc.) can be visible in a box 1710 to the immediate right of the slider bar 1704, and can continuously update as the slider control tab 1706 is being used.

Continuing with FIG. 17 to the right of the slider bar 1704 is a read only text box 1710 displaying the currently selected value and any units associated with the value. The text in the text box 1710 can be right justified, with a space between the numeric value and the unit. In addition, formatting rules for large numbers can be in effect. For example, instead of “15287”, the number should read “15,287” wherein commas separate groups of digits.

In other embodiments, the text box 1710 is not read only. Accordingly, a user can enter a value into the text box 1710. In turn, the slider control a tab 1706 would be adjusted on the slider bar 1704 corresponding to the entered in value.

To navigate through the values provided by the slider bar 1704, each full width of the slider bar 1704 can have a range of one hundred (100) units. The left most position of the slider can be one (1), while the right most position can be one hundred (100). For numbers greater than one hundred (100), a different mechanism can be used. The user can drag the slider control tab 1706 to the far right and remain holding it. For each half (½) second of holding the slider control tab 1706, the slider bar 1704 range can increase by one hundred (100).

For example, if the original range of the slider 1704 is one (1) to one hundred (100), and the user drags the slider control tab 1706 to the far right (“100” is visible in the value indicator) and holds their finger on the slider control tab 1706, the value will increase by one hundred (100) for each half (½) second. This means that after one and a half (1.5) seconds, the value in the box will be “400”. At this point, the user may slide the slider control tab 1706 to the left to choose a value between three hundred (300) and four hundred (400), or may remove his/her finger from the display 902 to remain at four hundred (400). The same is true in the reverse direction.

In another example, if the current slider bar 1704 scale is seven hundred (700) to eight hundred (800) but the user needs to choose one hundred and twenty five (125), the user would drag the slider control tab 1706 to the far left, and hold for three (3) seconds, until “100” appears in the value box 1710. The user would then drag to the right to choose one hundred and twenty five (125).

For very large numbers, the scale shifting can be accelerated, instead of the half (½) second times presented above. For example, in the event that the user needs a value such as twenty five hundred (2500), it should not take thirteen (13) seconds to reach that slider bar 1704 range.

In one embodiment, the slider 1706 range may not be divisible by increments of one hundred (100). If the maximum value is less than or equal to one hundred and fifty (150) more than the minimum value, the entire slider range should fit on one width. For example, if the minimum value is seven (7) and the maximum value is one hundred and fifty four (154), the entire range one hundred and forty seven (147), could fit on one slider bar 1704.

If the maximum value is greater than one hundred and fifty (150), then the default slider bar 1704 range can be one hundred (100) as described above. Subsequent ranges can be incremented by one hundred (100), until the last set, which can terminate at the maximum value. For example, if the maximum range is three hundred and forty seven (347), the slider bar 1704 can behave as described for one (1) through three hundred (300), but the slider bar 1704 range that would typically be three hundred (300) to four hundred (400) will instead be three hundred (300) to three hundred and forty seven (347).

If the minimum value is less than or equal to one hundred and fifty (150) less than the maximum value, the entire range should fit on one slider bar 1704. If the minimum value is greater than one hundred and fifty (150) less than the maximum value, the default behavior would be followed until the truncated range at the first slider bar 1704 range. For example, if the minimum value is forty seven (47) and the maximum value is three hundred and ninety (397), the first slider bar 1704 range would be forty seven (47) to one hundred (100), and the final slider bar 1704 range would be three hundred (300) to three hundred and ninety seven (397).

Generally, the default minimum value is one (1). However, if zero is indicated as a valid value, the scale can be adjusted to be from zero (0) to one hundred (100) for the first slider range. Typically, negative values are not allowed.

Manual Entry Input Controls.

As depicted in FIG. 18, illustrative manual entry input controls 1802 on the standard conversation window displayed on the wireless device 100 can also be provided for data gathering in accordance with one aspect of the present application. The manual entry input controls 1802 allow a user to input numeric values via manual entry.

In one embodiment, to enter this control 1802, the user taps a value indicator that can be displayed on the user interface, which can cause a numeric keypad to slide on the display 902 from the right. The user can manually tap numbers to enter a value, which can be visible at the top in a textbox 1804.

Manual entry also allows the user to change the units of the value. For example, if the input control defaults to asking for weight in pounds, but the user would like to enter it in kilograms, the user may tap the “Units” button 1806 at the bottom left to cycle between available units. Each tap of the button 1806 would change the units displayed in the textbox 1804 (“lbs” in the example). For weight, the units can cycle through “lb”, “oz”, and “kg”, while for length, the units can be “in”, “ft”, “mm”, and “cm”. If a value exists in the textbox 1804 and the user changes the units, the value will be cleared from the textbox 1804. For example, if the default unit is pounds, and the user types “5”, then changes the units to ounces, the “5” would be cleared. Alternatively, the unit “5” can be converted into a corresponding measurement. For example, “5” pounds can be converted into “80” ounces.

From the manual entry screen 1802, the user can tap the “back” button 1808 to return to the slider bar control. If a user changes the units of a value and returns to the numeric input control 1702, the new unit and the new value can be represented in the box 1710 and input label 1708 as well as the slider control tab 1706 on the slider bar 1704.

Preset Slider Values

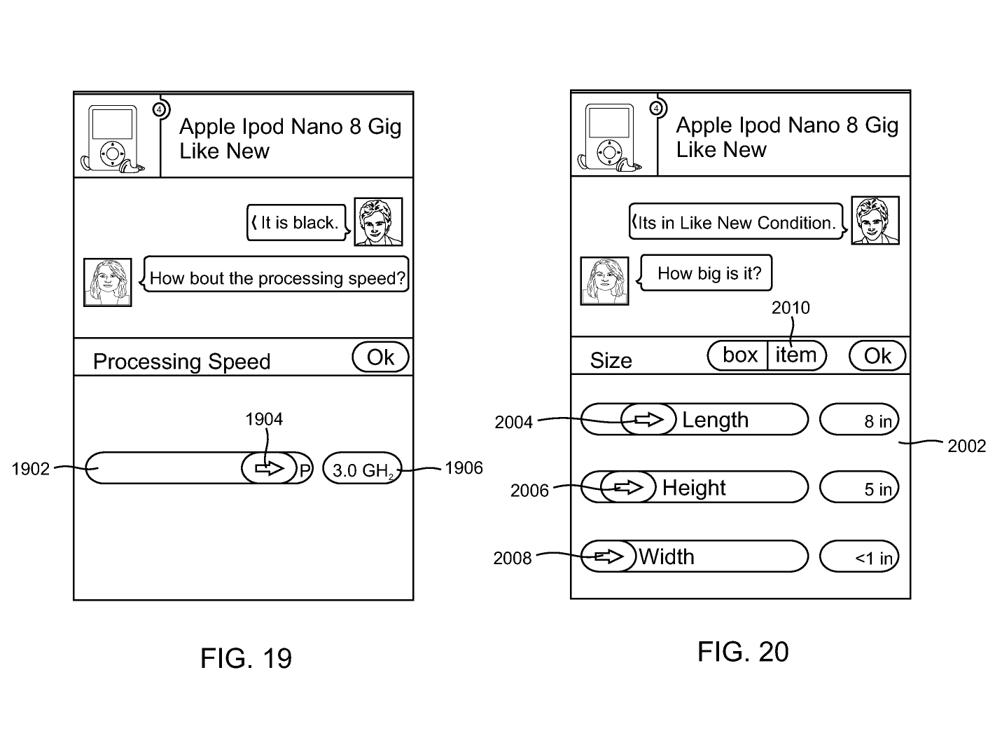

Typically, there will be numeric fields that have defined sets of values. For example, the “Processing Speed” attribute for a laptop computer can have set values. The value set can include discreet values in megahertz, such as “100”, “100”, “120”, “133”, “150”, “166”, etc. Rather than using the single select input controls 1402, as described above, for this numeric case, the values should be presented on a numeric slider control 1902, with each value indicated by a “notch” in the slider track as depicted in FIG. 19. The left most value would be “100 MHz”, and as the user slides the slider 1904 to the right, the value indicator 1906 would show “100 MHz”, then “120 MHz”, and on up to “3.0 GHz”. The preset slider values are important for online marketplaces such as eBay, which sometimes have predefined attribute lists.

Specialized Numeric Input Controls

In preferred embodiments of the present application, specialized numeric input controls can be provided. FIG. 20 shows illustrative physical dimension input controls 2002 on the standard conversation window displayed on the wireless device in accordance with one aspect of the present application. Typically, the physical dimension input controls 2002 include three numerical sliders 2004, 2006 and 2008. Numerical slider 2004 is for the length, while numerical slider 2006 is for height. In addition, numerical slider 2008 is for width. Through the three numerical sliders 2004, 2006 and 2008, packaging for an item may be determined.

Preferably, the default value for each slider 2004, 2006 and 2008 can be one (1) inch. The user can use the sliders 2004, 2006 and 2008 in the traditional way. In other embodiments, if the user presses and holds on the slider control tab and slides it to the left, even if it is at the left most position, the value indicator will change to “<1 in”. This can allow the user to specify thin items that might best be shipped in an envelope. To return to the standard range of values from “<1 in”, the user will simply slide the tab right.

Continuing with FIG. 20, at the top right of the input control box 2002, there is a toggle switch 2010 with the words “box” and “item”. This can allow the user to identify whether they are providing the dimensions of a packaged item (box), or the item itself (item). Following similar logic is the weight input control box. The default value will be 1 lb, unless otherwise specified, and the user is able to achieve a value of “<1 lb” by performing the same action as mentioned above.

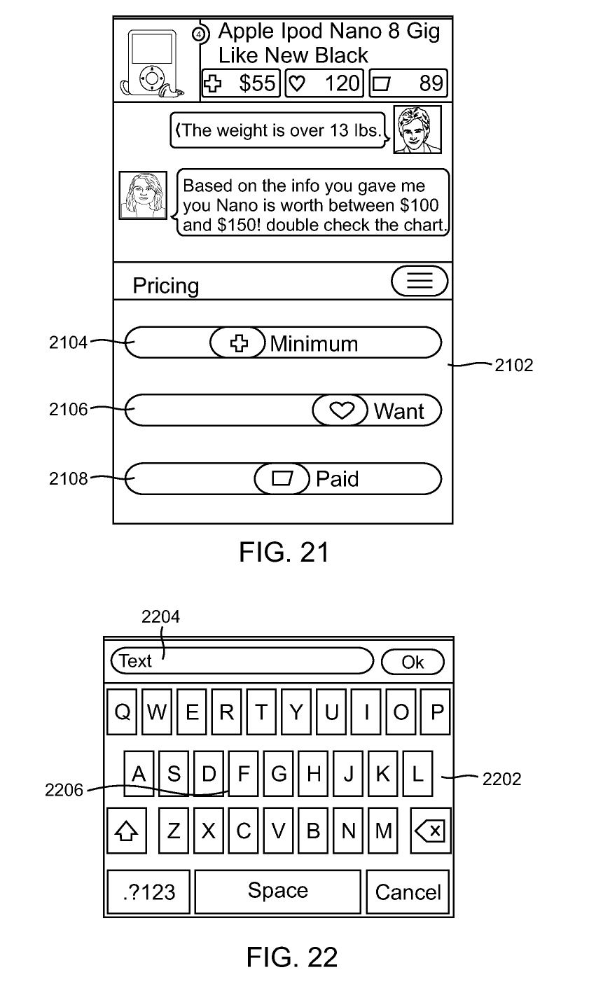

Other specialized numeric input controls may include pricing selection input controls 2102 as depicted in FIG. 21. In preferred embodiments, the pricing selection input controls 2102 also include three numeric sliders 2104, 2106 and 2108. Numerical slider 2104 titled “Minimum” is the minimum amount that a user is willing to accept for an item, while numerical slider 2106 titled “Want” is the price the user wants to sell the item for. Numerical slider 2108 titled “Paid” is the amount that the user paid for the item.

Generally, each of these controls will have a minimum value of one (1), with no option for “<1”. The “Want” value should always be greater than or equal to the “Minimum” value. This means that if the user slides “Want” to the left below the current “Minimum” value, the “Minimum” control will slide left with “Want” as soon as the two have the same value. Conversely, if the user wishes to move the “Minimum” greater than the current “Want” value, the “Want” control will slide right with the “Minimum”. The “Paid” control is independent of the other two.

Text Entry Input Controls

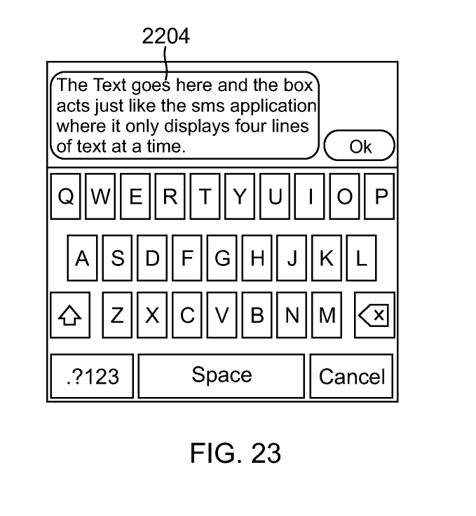

FIG. 22 depicts illustrative text input controls 2202 on the standard conversation window displayed on the wireless device 100 in accordance with one aspect of the present application. For cases where the user is able to enter text freely to a text box, a standard keyboard 2206 can be used. Atop the keyboard pane 2206 can be a text box 2204 where characters will appear as they are typed. The textbox 2204 defaults to being one line in height. However, when text is entered that wraps to new lines, the textbox 2204 can increase in height as depicted in FIG. 23. Generally, a maximum of four lines is provided. For text entry beyond four lines, the top lines will be hidden “above the fold” of the textbox 2204.

Price/Value Chart

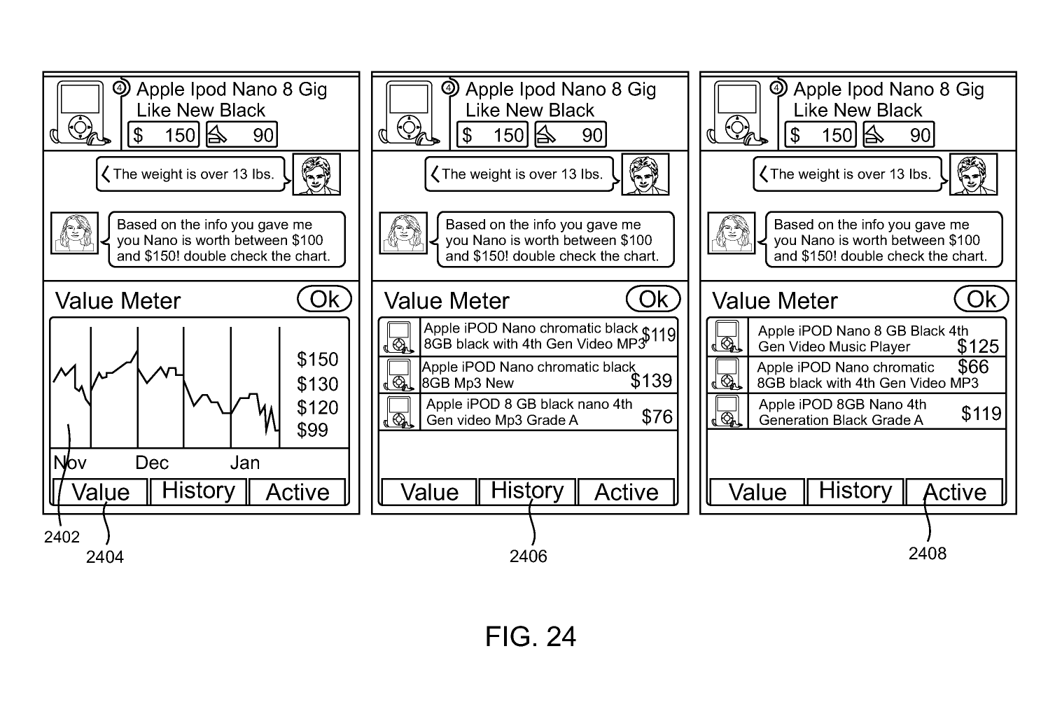

After data is gathered, the wireless device 100 can receive pricing data about an item using the data. Typically, a value chart 2402 can show the pricing data as shown in FIG. 24. As presented, the chart 2402 shows time on the horizontal (X) axis, and values on the vertical (Y) axis. Generally, coordinate points can be defined and the user interface can connect these points to form a line chart 2402. The Y-axis labels can be displayed to the right of the chart data 2402, and can range from the minimum value to the maximum value in the data. The X-axis labels can be displayed along the bottom of the chart 2402. The right most point indicates the present time, while the left most point indicates the earliest data point available. The labels themselves can include abbreviated months as shown.

Continuing with FIG. 12, three chart tabs 2404, 2406 and 2408 can be provided. As shown on the display 902 on the furthest left, the chart described above is presented. This chart is displayed when the “Value” Tab 2404 has been selected. The “History” Tab 2406 and the “Active” Tab 2408 change the chart view to a list of related completed listings or related active listings for the user to view prior to determining their pricing. If the user taps on either value box in the summary bar of the page, the user can see the specialized numeric input controls for pricing, described above. By clicking “back” on that input control box, the user will return to the chart 2402.

Review

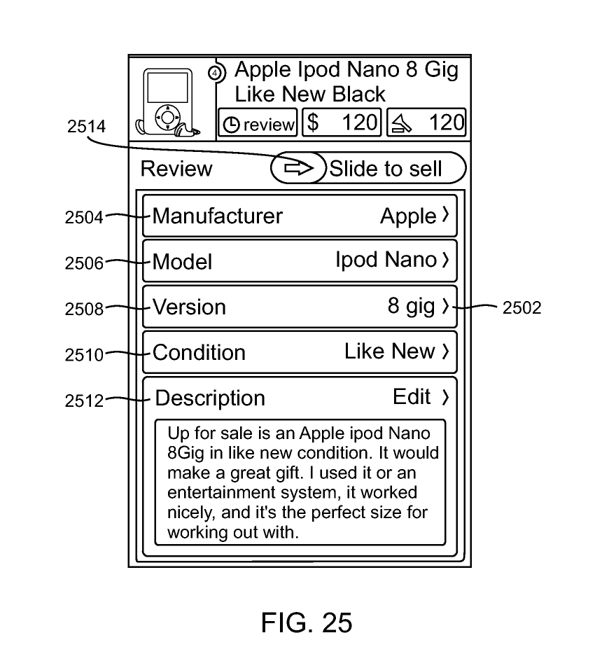

With reference now to FIG. 25, an exemplary review screen 2502 displayed on the wireless device 100 is presented. At the end of the new listing process is the review screen 2502, where the user can see the values chosen by them or the recommendation engine, and modify them if necessary. The layout will be similar in appearance to the single select input controls 1402. The review input control differs from other controls in that it fills the entire screen, completely hiding the conversation bubbles 1104 and 1204. Each bar will hold one name/value pair, for example “Manufacturer” 2504, “Model” 2506, “Version” 2508, “Condition” 2510, and “Description” 2512. On the right side of each bar are the corresponding values, typically in green. Each bar will be the same height, except for the Description field 2512, which will be expanded to show the content of the user's description.

By tapping on any bar 2504, 2506, 2508, 2510, and 2512, a new, blank chat window can slide in from the right side of the display 902, with a statement similar to “So, you want to change the condition?” and the appropriate condition input control box can appear. The previous selected value can be selected still, and the user can make a change and press “ok” to return to the review page (sliding in from the left), where the change will be reflected.

Vertical scrolling can behave the same as in the single selection input controls 1402. Preferably, when the description bar 2512 is about to hit the top of the scrolling track, it should collapse to be the same height as the other bars, so that the garage door effect does not have to be modified. When revealing the description bar 2512 while scrolling down, the description field will automatically expand to show the user's description once it is fully on the page. The top of the review control is a “slide to sell” control 2514, which the user can use to indicate that he/she is ready to list their item.

Summary Bar

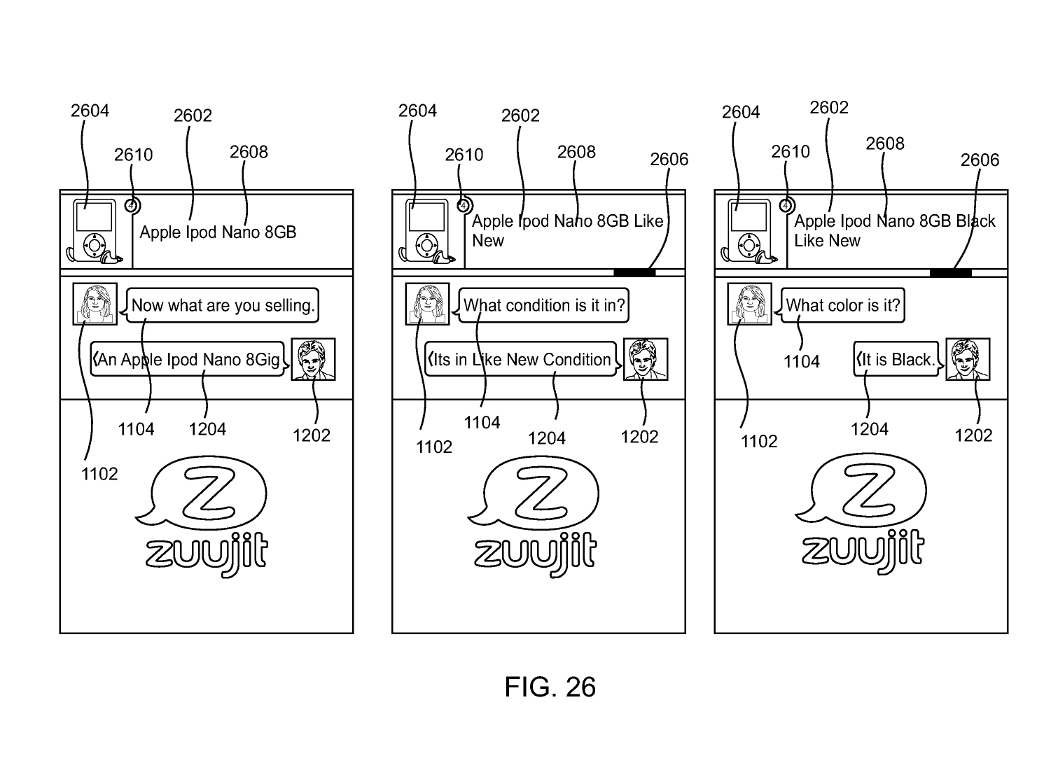

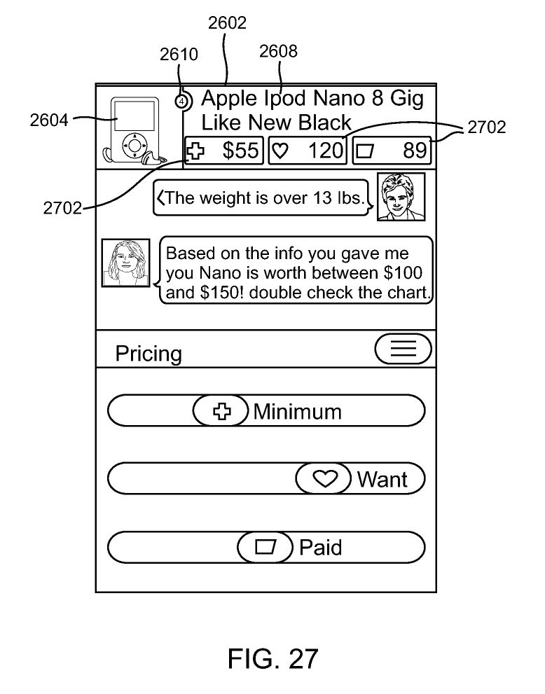

As shown in the previous FIGURES, and with specific reference now to FIGS. 26 and 27, a summary bar 2602 can be displayed throughout the entire conversation. Preferably, the summary bar 2602 is at the top of the display 902. Generally, the summary bar 2602 contains four distinct elements that include a Thumbnail 2604, Progress Bar 2606, Title 2608, and Pricing Value 2702.

On the left side of the summary bar 2602 is a thumbnail 2604 image of the primary/gallery image for the listing as shown in FIG. 26. The dimensions of this thumbnail 2604 can be seventy five (75) by seventy five (75) pixels. Alternatively, the dimensions of the thumbnail 2604 can be eighty (80) by eighty (80) pixels. In the event that there is more than one image attached to the listing, a red blue circle 2610 will appear with a number inside of it, indicating the total number of images. The red blue circle 2610 is to be centered horizontally on the left edge of the thumbnail, and aligned with the top of the thumbnail (as shown). There will be functionality to allow a user to view all of the attached images by tapping on this primary thumbnail 2604 image.

On top of the summary bar 2602 is a progress bar 2606 that visually indicates the current completeness of the new listing. The progress bar 2606 can be five (5) pixels in height, and will always fill the width of the screen. For a brand new listing (with no images), the progress bar can be completely dark. With each new piece of information added to the listing, a greater percentage of the progress bar 2606 can illuminate from the left side of the screen.

The progress bar 2606 can be three hundred and twenty (320) pixels in width, and can be broken down in the following way: the first two hundred and forty (240) pixels can be broken down to the number of steps of the new listing. In the case of an “apple ipod nano”, in which there are eight (8) total properties (two (2) of which are already known [brand=“apple” and product line=“ipod nano”], the total number of increments would be: images (1)+WAYS (1)+condition (1)+properties (6)+dimensions (1)+weight (1)+description (1)+pricing (1)=13. This means that each piece that is completed would result in eighteen (18) to nineteen (19) pixels (two hundred and forty (240) divided by thirteen (13)). Of course, if the dimensions and weight are already known, or if the item is a digital item, the thirteen (13) pieces then become eleven (11), and so forth. In every case, by the time the user gets to the review page, the progress bar 2606 should have at least two hundred and forty (240) pixels illuminated. The remaining eighty (80) pixels are broken down into two pieces: sixty (60) pixels for image uploading and twenty (20) pixels for review and listing submission. This means that if the user has attached seven (7) images to the listing, each image is eight (8) to nine (9) pixels each (sixty (60) divided by seven (7)). For each image that is successfully uploaded, the progress bar 2606 would increment by this amount. No matter what part of the listing the image successfully uploads (whether it's during WAYS or Condition, etc.), the progress bar 2606 can increment. Following this logic, if six (6) of the seven (7) images have uploaded by the time the user has reached the review page, then two hundred and ninety one (291) pixels (240+(6×8.5)) are illuminated. As soon as the user “slides to sell” and the listing is posted to an online market place, twenty (20) pixels will illuminate, and the remaining nine (9) can illuminate when the final image is uploaded.

To the right of the thumbnail 2604 on the summary bar 2602 is an area that can display the title 2608 for the listing. In preferred embodiments, the title 2608 changes as more information is gathered about the item. For example, initially the user enters “apple ipod nano 8 gig” and clicks “ok”. Immediately, the server identifies the Brand (Apple), ProductLine (iPod Nano), and Capacity (8 GB), so the text in the title should now be “Apple iPod Nano 8 GB”. As more properties are defined, those values can be added to the title following the parameterization. If the condition is asked, and the user chooses Like New, then the title 2608 at the top will now be “Apple iPod Nano 8 GB Like New”. Typically, this process continues until either all properties have been defined, or all variables in the title 2608 have been satisfied.

Once the user has specified pricing for their item, one or more value boxes 2702 will appear in the summary bar 2602 as shown in FIG. 27. When in the manual pricing mode (the default input control to show when receiving no research data), or the automatic pricing mode (achieved by tapping on any of the pricing value boxes in the summary bar while the pricing chart is showing), the icons on the sliders in the input control match those of the pricing value boxes 2702 in the summary bar 2602. Note that the icons shown in the image may not be the final icons. The “Paid” value is optional, and the third pricing value box 2702 can show if the user has chosen a value.

Methods of Operation

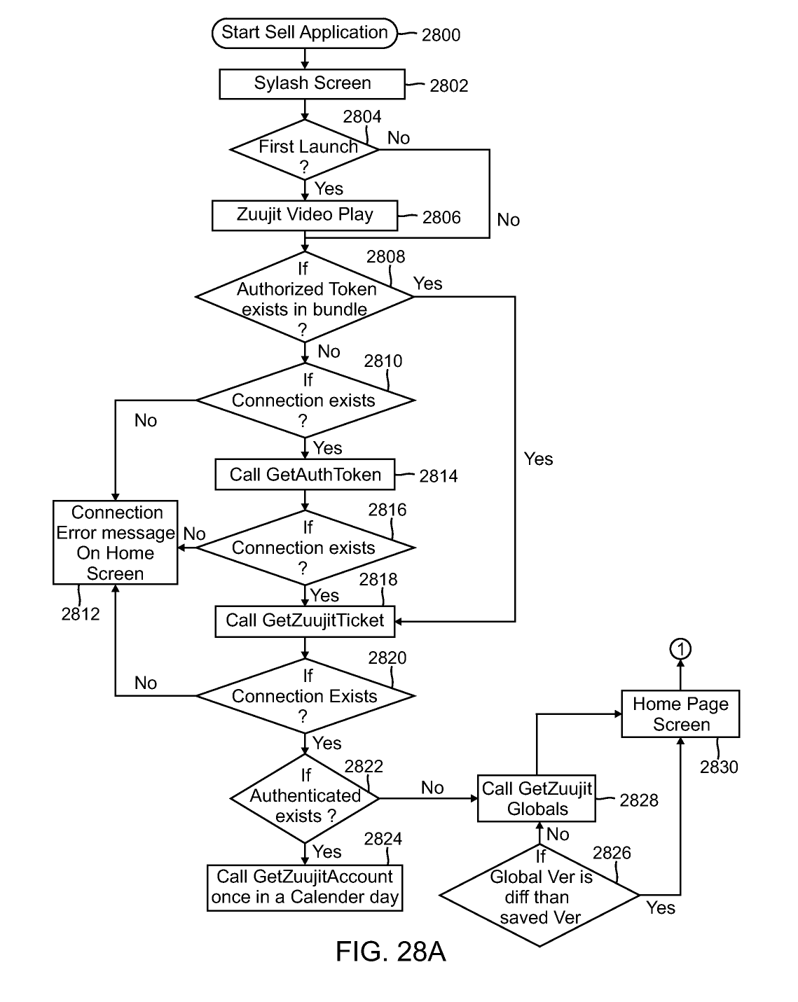

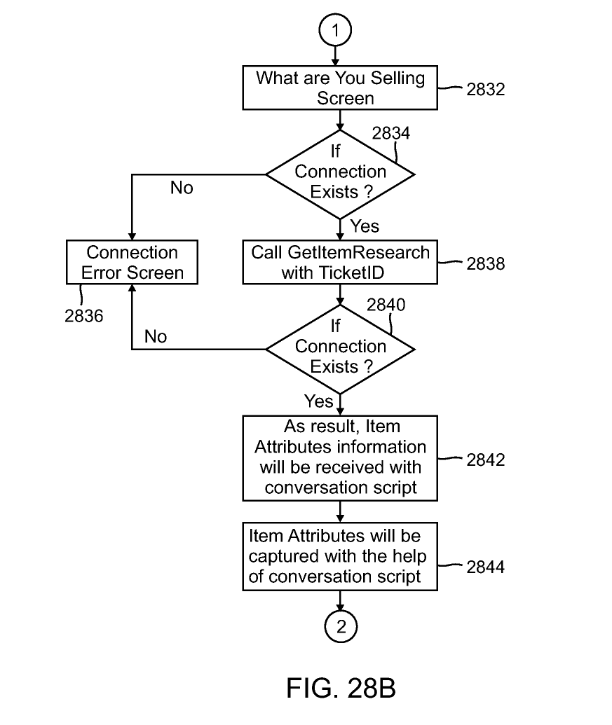

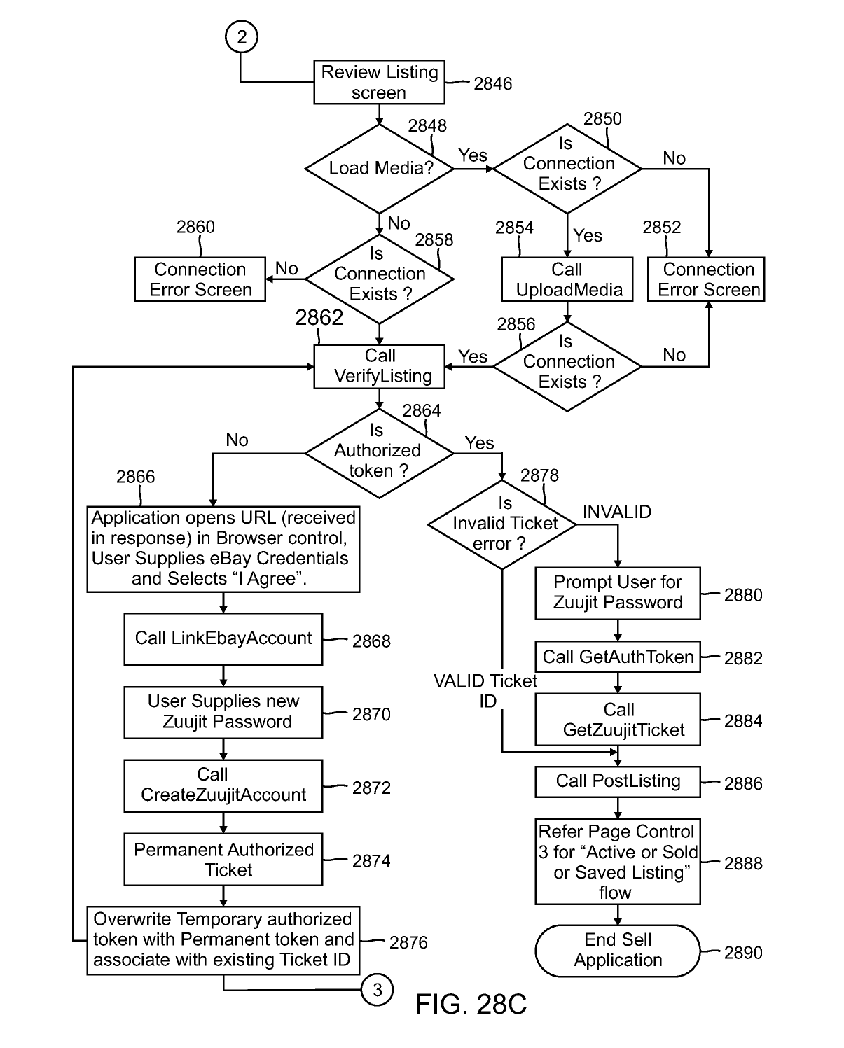

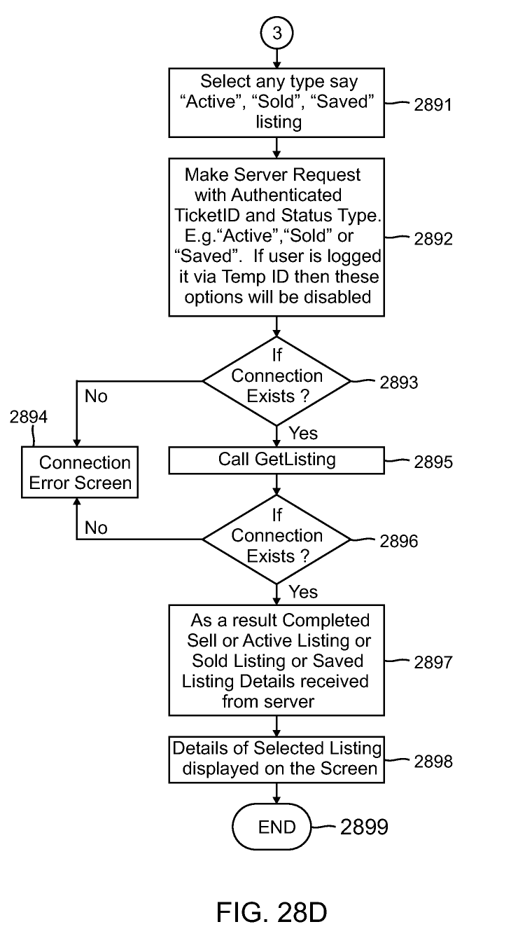

Previously, several screens that could be placed on display 902 were shown. Hereinafter, those screen shots will be described in more detail with respect to the Sell Application and more specifically, the methods of operation in which the Sell Application works with. FIG. 28A is an illustrative flow chart describing the login procedure for a Sell Application in accordance with one aspect of the present application. The login procedures start at block 2800. At block 2802, a splash screen is shown on the display 902 of the wireless device 100. The splash screen is similar to the one shown on FIG. 9.

At determination block 2804, the wireless device 100 decides whether the Zuujit Application has ever been launched. If not, the device 100 plays an introduction video at block 2806 and control is sent to determination block 2806. If the Zuujit Application has been launched before, then control is sent to determination block 2806.

At determination block 2808, device 100 determines whether an authorized token exists. If so, the wireless device 100 calls GetZuujitTicket at block 2808 and control is sent to determination block 2820. Otherwise, the wireless device 100 determines if an existing connection exists between the device 100 and the Zuujit Server 802 at determination block 2810.

When no connection exists, the wireless device 100 sends an error message on the home screen of the device 100 at block 2812. Alternatively, and if a connection exists, the device 100 calls GetAuthToken from the Zuujit Server 802 at block 2814. At determination block 2816, the wireless device 100 again determines if a connection exists to perform other routines. If there is no connection, the wireless device displays the error message at block 2812. If a connection does exist, the wireless device calls GetZuujitTicket at block 2818 and control is given to determination block 2820.

At determination block 2820, the wireless device 100 decides whether a connection exists. The wireless device 100 checks periodically for an existing connection as a result of wireless devices 100 often “dropping” connections. Again, an error message is provided at block 2812 when no connection exists.

At determination block 2822, the wireless device 100 authenticates a token. The token represents a valid user for Zuujit. When the token is authenticated, the device 100 calls GetZuujitAccount at block 2824. Otherwise, device 100 calls GetZuujitGlobals at block 2828 when the token cannot be authenticated. The login procedure ends at block 2830 where the device 100 returns to the home screen.

FIG. 28B is an illustrative flow chart describing the new listing procedure for the Sell Application in accordance with one aspect of the present application. These procedures are a continuation of the procedures described in the login process. At block 2832, the “What are You Selling Screen” is presented on the display 902 of the device 100, which was shown in FIG. 12.

At determination block 2834, wireless device 100 determines again whether a connection exists. When no connection exists, the device 100 displays the error screen at block 2836. On the other hand, when a connection does exist, the wireless device 100 calls GethemResearch at block 2838.

Again, at determination block 2840, wireless device 100 determines whether a connection exists. At block 2836, an error message is provided to the user if no connection exists. Alternatively, and when a connection does exist, the wireless device 100 receives item attributes at block 2842. At block 2844, item attributes are captured through the conversational interface described above.

FIG. 28C is an illustrative flow chart describing a post listing procedure for the Sell Application in accordance with one aspect of the present application. This procedure is a continuation of the procedures described in FIGS. 28A and 28B. The post listing procedure begins at block 2846 where the wireless device 100 displays the review listing screen as shown in FIG. 25.

At determination block 2848, the wireless device 100 decides whether media should be uploaded to the marketplace server 802. If so, at determination block 2850, the device 100 determines whether a connection exists. If no connection exists, the wireless device 100 sends a connection error to the display 902 at block 2852. If a connection exists, the device 100 calls UploadMedia at block 2854. At determination block 2856, wireless device determines whether a connection exists. If no connection exists, the device 100 sends a connection error to the display at block 2852. If a connection exists, the device calls VerifyListing at block 2862.

Returning to determination block 2848, when no media needs to be loaded, wireless device 100 determines whether a connection exists at determination block 2858. If no connection exists, wireless device 100 sends a connection error to the display 902 at block 2860. However, if a connection does exist, device 100 calls VerifyListing at block 2862 and control is sent to determination block 2864.

At determination block 2864, the device 100 determines whether the user has an authorized token. If not, the application opens the uniform resource link (URL) to the Marketplace Server 802 at block 2866. The user can supply the Marketplace Server 802 with credentials and select other pertinent information. Furthermore, the user can select “I Agree” on the Marketplace Server 802.

In one embodiment, at block 2868, the device 100 calls LinkEbayAccount. Other calls may be made to other Marketplace Servers 802 or auction sites. At block 2870, the user can supply a new password. The device 100 calls CreateZuujitAccount at block 2872. At block 2874, device 100 authorizes a ticket. At block 2876, device 100 overwrites the temporary authorized token with a permanent token and associates it with an existing ticket ID. Control is returned to block 2862

Returning to determination block 2864, if there is an authorized token, device 100 determines whether there is an invalid ticket error at determination block 2878. When there is an invalid ticket, the device 100 prompts the user for a password at block 2880. The device 100 calls GetAuthToken at block 2882. At block 2884, the device 100 calls GetZuujitTicket and at block 2886, device 100 calls PostListing

Returning to determination block 2878, device 100 calls PostListing at block 2886 when a valid ticket ID has been obtained. At block 2888, device 100 waits for active, sold or saved listing instructions. The Sell Application ends at block 2890.

FIG. 28D is an illustrative flow chart describing the active or sold listing procedure for the Sell Application in accordance with one aspect of the present application. At block 2891, the device 100 allows the user to select “Active”, “Sold”, and “Saved” listings. The device 100 makes a server request with an authenticated ticket ID and status type, for example, “Active”, “Sold” or “Saved”. If the user is logged in via their temp ID, then these options will be disabled.

At determination block 2893, device 100 determines whether a connection exists. If no connection exists, the device displays a connection error to the user at block 2894. If a connection does exist, device 100 calls GetListing at block 2895.

At determination block 2896, device 100 again determines whether there is a connection. If not, the device displays a connection error to the user at block 2894. If there is a connection, at block 2897, item details are received from the Marketplace Server 802 by the device 100. At block 2898, details of the selected listing are displayed on the screen. The sold listing procedure ends at block 2899.

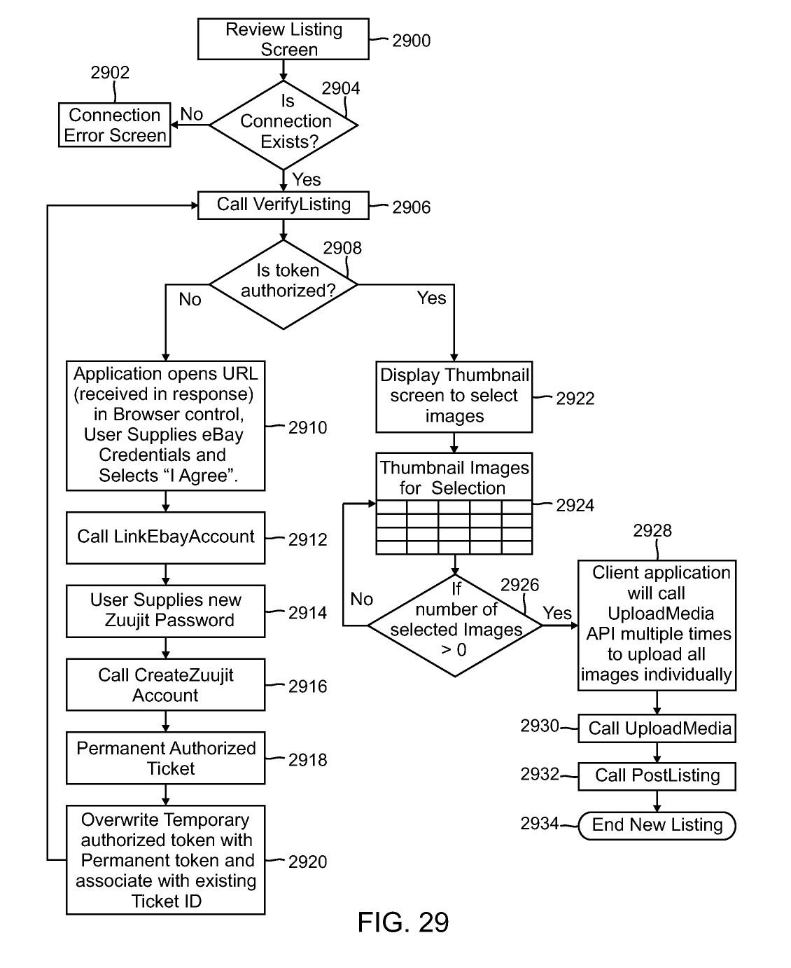

FIG. 29 is an illustrative flow chart describing the upload media procedure for the Sell Application in accordance with one aspect of the present application. Beginning at block 2900, device 100 displays the review listing screen as shown in FIG. 25. At determination block 2904, device 100 decides whether a connection exists. If no connection exists, the device 100 displays a connection error to the user at block 2902. Otherwise, the device 100 calls VerifyListing at block 2906.

At determination block 2908, device 100 decides whether a token has been authorized. If not, the device opens a URL in the browser control. The user supplies marketplace information, such as eBay credentials, and selects “I Agree” at block 2910. At block 2912, device 100 calls LinkEbayAccount, or any other marketplace server 802. At block 2914, the user supplies a new password. At block 2916, the device 100 calls CreateZuujitAccount.

At block 2918, a permanent ticket is authorized. The device 100 overwrites the temporary authorized token with a permanent token and associates it with an existing ticket ID at block 2920. Control is returned to block 2906.

Returning to determination block 2908, device displays a thumbnail screen for the user to select images at block 2922 when there is an authorized token. At block 2924, a user can select thumbnail images. At determination block 2926, device 100 determines if the number of selected images is greater than zero. If not, device 100 returns to block 2924.

On the other hand, device 100 calls UploadMedia multiple times to upload all images individually at block 2928 when the number of selected images is greater than zero. At block 2930, device 100 calls upload media. At block 2932, device 100 calls PostListing and the procedure ends at block 2934.

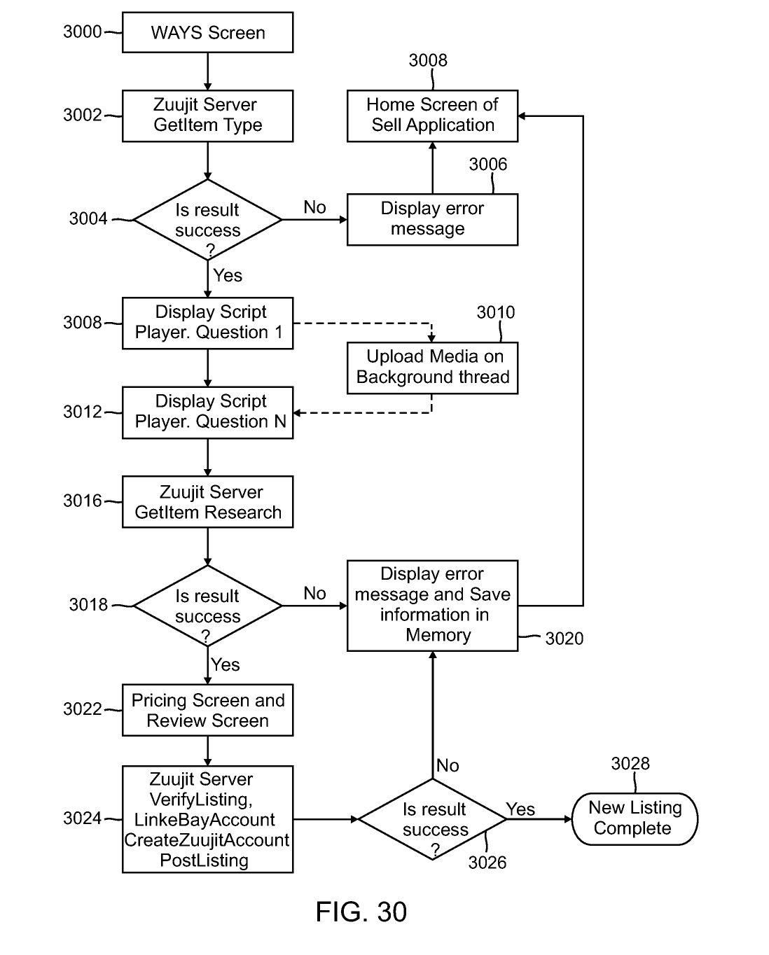

FIG. 30 is an illustrative flow chart describing the a no connectivity procedure for the Sell Application in accordance with one aspect of the present application. At block 3000, the WAYS screen is presented to the user. The Zuujit Server calls GetItemType at block 3002. At determination block 3004, device 100 decides whether the results from the GetItemType is successful. If not, the device 100 displays an error message at block 3006. At block 3008, the home screen of the Sell Application is displayed.

Returning to determination block 3004, if the result of the GetItemType was successful, the device 100 displays the script player and Question 1 to the user at block 3008. Simultaneously, device 100 executes UploadMedia on a background thread at block 3010.

At block 3012, the device 100 displays the script player and Question N. At block 3016, the device calls GetItemResearch. At determination block 3018, device 100 determines whether the GetItemResearch call was successful. If no, the device 100 displays an error message and saves information in memory at block 3020. The home screen of the sell application is displayed at block 3008.

If the GetItemResearch call was not successful, device 100 displays the pricing screen and review screen as shown in FIGS. 24 and 25 at block 3022. The device 100 then calls VerifyListing, LinkEbayAccount, CreateZuujitAccount, and PostListing at block 3024.

At determination block 3026, the device 100 determines whether the calls were successful. If not, control is sent to block 3020 where an error message is displayed and the device 100 saves information in memory. If however, the results were successful, device 100 completes the new listing at block 3028.

Aspects of the Present Application

In accordance with one aspect of the present application, an application on a GUI provided on a display screen of a computer system is presented. The application includes a digitized character for driving a conversation to gather data. In addition, the application includes a user profile for interacting with the digitized character to maintain the conversation. The conversation occurs through chat bubbles and when needed, additional input controls are provided for the data gathering.

In accordance with another aspect of the present application, a GUI for use with a browser on a computer is presented. The GUI includes a web page capable of being displayed on the browser of the computer. The web page includes a character image that displays a set of questions and a user icon that responds to the set of questions through input from the browser so that the computer can determine information from the provided responses.

In accordance with yet another aspect of the present application, a mobile device is presented. The mobile device includes a display having touch screen capabilities, a GUI provided on the display, at least one processor, and a memory operatively coupled to the processor. The memory stores program instructions, that when executed by the processor, causes the processor to display a digitized character and a user profile on the GUI. The digitized character provides a set of questions to the user profile. The user profile responds to the set of questions answered through a user by the GUI.

In accordance with another aspect of the present application, a computer-implemented method for retrieving information from a user using an application displayed on a GUI that facilitates conversations between the computer, taking on a form of a digital character, and the user, taking on a form of a user profile, within the application. The application includes chat bubbles between the digital character and the user profile to obtain information. The chat bubbles provide a conversation that can be read from top to bottom on the GUI with new chat bubbles appearing at the bottom of the GUI. The chat bubbles are capable of being edited on the GUI and can expand in both width and height to accommodate text entered into the chat bubbles.

In addition, the application includes input controls associated with the chat bubbles for the user to enter in information about the item. The input controls include single selection controls for allowing the user to enter in required and optional information. The single selection controls provide scrolling animation, the scrolling animation characterized by having a garage door effect. In addition, the input controls include multi-selection controls allowing the user to enter in more than one value for the information about the item. Furthermore, the input controls include numeric controls allowing the user to enter in amounts, wherein the numeric controls include a slider bar, value indicator, and manual entry. The input controls also include text entry controls allowing the user to enter in text. The text entry controls expand in both width and height to accommodate entered text.

In accordance with still yet another aspect of the present application, a method for interactive data gathering using a conversational interface having visual representations on a wireless device having a display screen and a GUI is presented. The method includes parsing and rendering an extensible markup language (XML) document, which when parsed and rendered, the GUI providing a two-way dialogue between a digital character and a user of the wireless device to obtain information about an item. The two-way dialogue is similar to short text message services (SMS).

The two-way dialogue includes chat bubbles between the digital character and the user to obtain information about the item. The chat bubbles provide a conversation that can be read from top to bottom on the GUI with new chat bubbles appearing at the bottom of the GUI. The chat bubbles are capable of being edited on the GUI and can expand in both width and height to accommodate text entered into the chat bubbles.

In addition, the two-way dialogue includes input controls associated with the chat bubbles for the user to enter in information about the item. The input controls includes single selection controls for allowing the user to enter in required and optional information, wherein the single selection controls provide scrolling animation, the scrolling animation characterized by having a garage door effect. In addition, the input controls include multi-selection controls allowing the user to enter in more than one value for the information about the item. Furthermore, the input controls include numeric controls allowing the user to enter in amounts, wherein the numeric controls include a slider bar, value indicator, and manual entry. The input controls also include text entry controls allowing the user to enter in text, wherein the text entry controls expand in both width and height to accommodate entered text. The input controls include physical dimension controls allowing the user to enter in dimensions for packing the item. The input controls include pricing selection controls allowing the user to enter in the minimum amount the user is willing to accept for the item, a price the user wants to sell the item for, and an amount the user paid for the item.

Continuing with the present aspect, the method further includes sending a request to the online marketplace management system to retrieve pricing data for the item based on the information obtained from the two-way dialogue. In addition, the method includes generating a price/value chart based on the pricing data received from the online marketplace management system and displaying the chart on price/value the GUI to the user. Furthermore, the method includes allowing the user to enter in a price for the item and review the information about the item and sending the information, including the price, for the item to the online marketplace management system. The online marketplace management system posts the information about the item so that buyers may purchase the item by viewing the information entered in by the user using the GUI.

In accordance with another aspect of the present application, a computer readable medium storing instructions for causing at least one processor to perform the methods provided above is presented.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

While the present invention has been described with regards to particular embodiments, it is recognized that additional variations of the present invention may be devised without departing from the inventive concept.

What is claimed is:

1. An application on a graphical user interface (GUI) provided on a display screen of a computer system, the application comprising:
a digitized character for driving a conversation to gather data;
a user profile for interacting with the digitized character to maintain the conversation, wherein the conversation occurs through chat bubbles and when needed, additional input controls are provided for the data gathering.

2. A mobile device comprising:
a display having touch screen capabilities;
a graphical user interface (GUI) provided on the display;
at least one processor; and
a memory operatively coupled to the processor, the memory storing program instructions that when executed by the processor, causes the processor to:
display a digitized character and a user profile on the GUI, wherein the digitized character provides a set of questions to the user profile, the user profile responding to the set of questions answered through a user by the GUI.

3. A computer-implemented method for retrieving information from a user using an application displayed on a graphical user interface (GUI) that facilitates conversations between the computer, taking on a form of a digital character, and the user, taking on a form of a user profile, within the application, the application comprising:
chat bubbles between the digital character and the user profile to obtain information, wherein the chat bubbles provide a conversation that can be read from top to bottom on the GUI with new chat bubbles appearing at the bottom of the GUI, the chat bubbles capable of being edited on the GUI and can expand in both width and height to accommodate text entered into the chat bubbles; and
input controls associated with the chat bubbles for the user to enter in information about the item, the input controls comprising:
single selection controls for allowing the user to enter in required and optional information, wherein the single selection controls provide scrolling animation, the scrolling animation characterized by having a garage door effect;
multi-selection controls allowing the user to enter in more than one value for the information about the item
numeric controls allowing the user to enter in amounts, wherein the numeric controls include a slider bar, value indicator, and manual entry;
text entry controls allowing the user to enter in text, wherein the text entry controls expand in both width and height to accommodate entered text.
